(19) United States
(12) Patent Application Publication
(10) Pub. No.: US 2026/0359026 A1
(43) Pub. Date: Nov. 12, 2026

(54) SYSTEM FOR IN-FIELD TRANSLATION OF NEURAL PROCESSING UNIT PRE-COMPILED BINARIES

(71) Applicants: Intel Products IP LLC, Santa Clara, CA (US); Intel Corporation, Santa Clara, CA (US)

(72) Inventors: Stavros Passas, Tyrrelstown (IE); Gary Baugh, Bray (IE); Srikanth Vasuki, Castleknock (IE)

(73) Assignees: Intel Products IP LLC, Santa Clara, CA (US); Intel Corporation, Santa Clara, CA (US)

(21) Appl. No.: 19/717,050

(22) Filed: Jun. 23, 2026

Related U.S. Application Data
(60) Provisional application No. 63/875,648, filed on Sep. 4, 2025.

(51) Int. Cl. G06F 8/52; G06N 3/04

(52) U.S. Cl. CPC G06F 8/52; G06N 3/04

(57) ABSTRACT

A compiler can process a graph of an artificial intelligence (AI) model and generate a compiled binary asset through two phases. The AI model may include AI operators, such as matrix multiplication, convolution, and activation functions. In the pre-compilation phase, the compiler may target a first hardware configuration and produce a binary containing task descriptor lists that instruct an NPU of the first hardware configuration to execute the AI operators. In the post-compilation phase, the compiler may remap the tasks to a second hardware configuration, which may differ from the first hardware configuration in the number of copy engines, fixed-function engines, or programmable engines, or in local memory size. Remapping strategies of the compiler may include direct translation, emulation, serialization, or merge. The resulting task descriptors for the second hardware configuration can be used by an NPU of the second hardware configuration to execute the AI model.

### CROSS-REFERENCE TO RELATED APPLICATION

This application claims the benefit of U.S. Provisional Patent Application No. 63/875,648, filed Sep. 4, 2025, and titled “SYSTEM FOR IN-FIELD TRANSLATION OF NEURAL PROCESSING UNIT PRE-COMPILED BINARIES,” which is incorporated by reference in its entirety for all purposes.

### TECHNICAL FIELD

This disclosure relates generally to artificial intelligence (AI), and more specifically to a system for in-field translation of neural processing unit (NPU) pre-compiled binaries.

### BACKGROUND

Neural networks (also referred to as “deep neural networks” or “DNNs”) are used extensively for a variety of AI applications ranging from natural language processing to computer vision, speech recognition, and image processing due to their ability to achieve high accuracy. However, the high accuracy comes at the expense of significant computation cost. DNNs have extremely high computing demands as there can be a large number of operations as well as a large amount of data to read and write. Therefore, techniques to improve the efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 is a block diagram of an AI system, in accordance with various embodiments.

FIG. 2 illustrates a configurable NPU architecture, in accordance with various embodiments.

FIG. 3 illustrates a compute module, in accordance with various embodiments.

FIG. 4 illustrates two-phase NPU compilation, in accordance with various embodiments.

FIG. 5 illustrates task descriptor translations, in accordance with various embodiments.

FIG. 6 illustrates task descriptors for NPUs with different configurations, in accordance with various embodiments.

FIG. 7 is a block diagram of a DNN module, in accordance with various embodiments.

FIG. 8 illustrates an example transformer model, in accordance with various embodiments.

FIG. 9 illustrates an example convolutional neural network (CNN), in accordance with various embodiments.

FIG. 10 is a flowchart of a method of executing a DNN, in accordance with various embodiments.

FIG. 11 illustrates an example sparse cell, in accordance with various embodiments.

FIG. 12 illustrates an example sparse cell array, in accordance with various embodiments.

FIG. 13 illustrates an example processing element (PE), in accordance with various embodiments.

FIG. 14 is a block diagram of an example computing device, in accordance with various embodiments.

### DETAILED DESCRIPTION

The last decade has witnessed a rapid rise in AI-based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more operations, such as matrix multiplication, convolution, interpolation, layer normalization, batch normalization, SoftMax operation, pooling, elementwise operation, linear operation, non-linear operation, and so on. These operations are referred to as deep learning operations or neural network operations.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and a Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

AI accelerators are a new area of processing units which are changing rapidly. With each change legacy compatibility breaks forcing re-engineering. From NPU generation to generation, the NPU hardware changes in many aspects, such as different number of compute elements, larger multiply-accumulate (MAC) arrays, local memories, and so on. Within the same NPU generation, there can be multiple SKUs (Stock Keeping Units) with different compute module counts or local memory sizes. This becomes a challenge for porting AI application on a new NPU generation and tuning KPIs (Key Performance Indicators) and for developing hardware without a supported NPU compiler. Pre-compiled binary generated for a particular NPU configuration and SKU are typically not portable for other NPU configurations. Existing solutions rely on engineering samples or an early version of the compiler. However, the early versions of silicon and compiler can have bugs. Alternatively, the previous generation test vectors or pre-compiled binaries for the latest design iteration are used. However, significant engineering is needed to reuse older pre-compiled binaries.

Embodiments of the present disclosure may improve on at least some of the challenges and issues described above by providing a two-phase compilation approach. In an example, an NPU compiler can compile a DNN model through a pre-compilation phase and a post-compilation phase. The pre-compilation may target a specific NPU hardware configuration that is different from the configuration of the NPU executing the DNN model. A set of pre-compiled binaries can be produced and retained. The post-compilation phase may be aware of the configuration of the NPU executing the DNN model and take the pre-compiled binaries to generate a new set of binaries targeting the new hardware. The post-compilation process may run once for deployment to the NPU executing the DNN model and may be retained for subsequent use. With this approach, AI models can be compiled for a specific NPU configuration X to produce a list of tasks for each of the hardware engines. From the compilation process there may be a binary asset which encodes all the task lists. This pre-compiled binary can be reused for inference execution on a NPU configuration Y, which may not be known at compilation time. With this approach, backward compatibility of NPU inference models/binaries can be guaranteed with newer NPU design configurations.

In various embodiments of the present disclosure, a compiler may obtain a graph of a DNN model. The graph may include nodes representing AI operators of the DNN model and edges representing data flows between the AI operators. The AI operators may include matrix multiplication (MatMul) operator, convolution operator, layer normalization operator, embedding operator, elementwise operator, activation function operator, and so on. The compiler may generate compiled binary asset for the DNN model through two chronologically distinct phases: a pre-compilation phase and a post-compilation phase. In the pre-compilation phase, the compiler uses NPU configuration X to produce a pre-compiled binary asset for the DNN model. The binary asset may include one or more lists of tasks. A list of tasks may include task descriptors that instruct a target NPU to execute the AI operators. The target NPU may have NPU configuration Y that is different from NPU configuration X. For instance, NPU configuration Y may have fewer or more copy engines, fixed-function engines, or programmable engines than NPU configuration X. Additionally or alternatively, NPU configuration X may have a larger or smaller local memory than NPU configuration Y. In the post-compilation phase, the compiler may remap the tasks in the pre-compiled binary to NPU configuration Y. For instance, the compiler may directly translate a task descriptor for a fixed-function engine of NPU configuration X to a task descriptor for a fixed-function engine of NPU configuration Y. Additionally or alternatively, the compiler may emulate a task descriptor for a fixed-function engine of NPU configuration X to a task descriptor for a programmable engine of NPU configuration Y. The compiler may also merge multiple task lists for NPU configuration X into a single task list for NPU configuration Y. The compiler may store task descriptors for NPU configuration Y in a memory, e.g., a system memory coupled with the NPU or a local memory of the NPU. The compute or copy engines of the NPU can fetch the task descriptors from the memory and execute the DNN model using the task descriptors.

With the approach in this disclosure, AI models pre-compiled for a particular NPU configuration (e.g., a previous NPU generation) can be functional on other NPU configurations (e.g., later NPU generations). This can enable shift-left development targeting the latest NPU generation design. This approach can look at in-memory binary translation mechanisms to make a legacy pre-compiled binary portable across new NPU generations through binary translation. Therefore, the previous generation NPU compiler can be leveraged for the latest design. In parallel, the NPU compiler can be optimized for the latest hardware design to target power and performance KPIs.

For purposes of explanation, specific numbers, materials and configurations are set forth to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

FIG. 1 is a block diagram of an AI system 100, in accordance with various embodiments. The AI system 100 may train, compile, and deploy DNN models to perform AI tasks, such as computer vision tasks, language processing tasks, speech recognition tasks, and so on. In some embodiments, the AI system 100 may be at least part of a computing device, such as an AI server or an AI personal computer. As shown in FIG. 1, the AI system 100 includes an NPU 101, an NPU 102, a DNN module 103, and a system memory 110. The AI system 100 may include fewer, more, or other components. A component of the NPU 101 may be implemented in hardware, software, firmware, or some combination thereof. Functionality attributed to a component of the AI system 100 may be accomplished by a different component included in the AI system 100 or by a different system. In some embodiments, the DNN module 103 may be implemented in a different type of processing unit from the NPU 101. For instance, the DNN module 103 may run on a host device, e.g., a host CPU. The different processing units may be separate chips, which may be connected through interconnect fabric.

The DNN module 103 facilitates generation and deployment of DNNs. In some embodiments, the DNN module 103 may generate, train, and compile DNNs. For instance, the DNN module 103 can define the layered architecture of a DNN. The DNN module 103 can also determine the internal parameters of the DNN through a DNN training process. The DNN module 103 may also determine one or more hyperparameters that define how the DNN is trained. An example hyperparameter is a sparsity ratio that defines the sparsity level of one or more deep learning tensors for the DNN.

The DNN module 103 may generate executable DNN models, such as DNN models that can be executed by the NPU 101 or NPU 102. For instance, the DNN module 103 may generate instructions (e.g., task descriptors) that control the operation of the NPU 101 during the DNN execution. In some embodiments, the DNN module 103 may compile a DNN and generates compute task descriptors and copy task descriptors. The DNN module 103 may write compute task descriptors and copy task descriptors into the system memory 110. The compute task descriptors may be instructions that control how the NPU 101 or NPU 102 performs computations in the DNN. The copy tasks descriptors may be instructions that control how the NPU 101 or NPU 102 fetches data from the system memory 110.

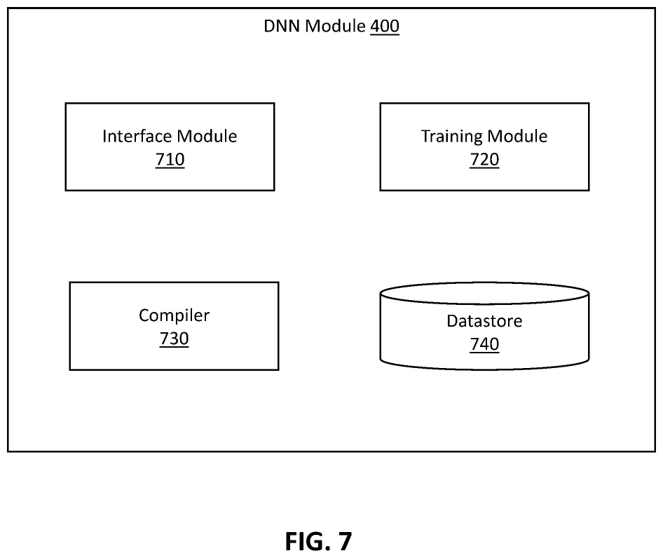

In some embodiments, the DNN module 103 may be the host for the execution of neural network operations by the NPU 101, e.g., the host for DNN inference. The DNN module 103 may control execution processes of trained, compressed, or validated DNNs. The DNN module 103 may also receive and process inference requests, e.g., requests to have a DNN model to make a prediction based on input data. The DNN module 103 may schedule inference jobs based on information in the requests. The DNN module 103 may also partition workloads for executing DNN layers into smaller workloads and determine allocation of the smaller workloads to tiles in the NPU 101. In some embodiments, the DNN module 103 may receive an output of the DNN from the NPU 101. The DNN module 103 may transmit the output of the DNN (or a result of processing the output of the DNN by the DNN module 103) to the device or system. Certain aspects of the DNN module 103 are provided below in conjunction with FIG. 7.

The system memory 110 stores data received, processed, or generated by the NPU 101, NPU 102, and DNN module 103. For instance, the system memory 110 receives data associated with DNN execution, such as internal parameters of DNNs, activations, inputs and outputs of DNNs, training dataset, compilation descriptors, and so on. In some embodiments, the system memory 110 may store data of various precisions, including floating-point precisions, such as FP4, SF4, NF4, FP16, BP16, FP32 and so on. In some embodiments, the system memory 110 includes one or more DRAMs.

The NPU 101 or NPU 102 may also be referred to as a DNN accelerator or AI processor. The NPU 101 can execute DNNs. For instance, the NPU 101 or NPU 102 can execute layers in a DNN by carrying out AI operators in DNN models, such as matrix multiplication (MatMul) operator, convolution operator, linear transformation operator, layer normalization operator, activation function operator, and so on. The AI operators in a DNN model may be arranged in a sequence, and the NPU 101 or NPU 102 may execute the layers in the sequence. The execution of a DNN by the NPU 101 or NPU 102 may be for training the DNN or for using the DNN to perform AI tasks.

As shown in FIG. 1, the NPU 101 includes a copy engine 120, a local memory 130, and a programmable engine 140, and a fixed-function engine 150. In other embodiments, alternative configurations, different or additional components may be included in the NPU 101. For example, the NPU 101 may include more than one copy engine 120, local memory 130, programmable engine 140, or fixed-function engine 150. Further, functionality attributed to a component of the NPU 101 may be accomplished by a different component included in the NPU 101 or by a different system. A component of the NPU 101 may be implemented in hardware, software, firmware, or some combination thereof.

The copy engine 120 facilitates data transfer between the system memory 110 and the local memory 130. For example, the copy engine 120 can read data from the system memory 110 and write data into the local memory 130. As another example, the copy engine 120 can read data from the local memory 130 and write data into the system memory 110. Data fetched or written by the copy engine 120 may include descriptors (e.g., compute task descriptors, copy task descriptors, etc.), weights, activations, and so on. In some embodiments, the copy engine 120 may fetch compute task descriptors from the system memory 110 based on auto-fetch descriptors provided by the programmable engine 140 or fixed-function engine 150. In some embodiments, the auto-fetch descriptors may be embedded in compute task descriptors. For instance, the copy engine 120 may transfer a compute task descriptor with an auto-fetch descriptor from the system memory 110 to the local memory 130. The programmable engine 140 or fixed-function engine 150 may fetch the two descriptors from the local memory 130 and may provide the auto-fetch descriptor to the copy engine 120 for the copy engine 120 to fetch the next compute descriptor group.

In some embodiments, the copy engine 120 may be a direct memory access (DMA) engine. The copy engine 120 may have a DMA feature that allows the programmable engine 140 or fixed-function engine 150 to initiate data transfer between the system memory 110 and the local memory 130 and to perform other operations while the data transfer is being conducted. In some embodiments, the copy engine 120 may read tensors from the system memory 110, modify the tensors in a way that is optimized for the programmable engine 140 or fixed-function engine 150 before it writes the tensors into the local memory 130.

The local memory 130 is local to the NPU 101. In some embodiments, the local memory 130 may be placed within the NPU 101. The local memory 130 is accessible to both the programmable engine 140 and fixed-function engine 150. In the embodiments of FIG. 1, the local memory 130 is inside the NPU 101. In other embodiments, the local memory 130 may be outside the NPU 101. Data in the local memory 130 may be transferred to or from the system memory 110, e.g., through the copy engine 120. In some embodiments, data in the local memory 130 may be transferred to or from the local memory of another NPU. The local memory 130 may store data received, used, or generated by the programmable engine 140 or fixed-function engine 150. Examples of the data may include compute task descriptors, auto-fetch descriptors, input activations, weights, output activations, and so on.

In some embodiments, the local memory 130 includes one or more SRAMs. The local memory 130 may be byte-addressable, and each memory address identifies a single byte (eight bits) of storage. In some embodiments, the local memory 130 may include memory banks. The number of data banks in the local memory 130 may be 16, 64, 128, 156, 512, 124, 2048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 130 in a single read cycle. In other embodiments, 16 bits can be transferred from the local memory 130 in multiple read cycles, such as two cycles.

The programmable engine 140 can execute software kernels of DNN models. The programmable engine 140 may be a general-purpose programmable engine. In some embodiments, the programmable engine 140 can perform generic computations such as addition, subtraction, multiplication, division, logical, bitwise operations, and other non-linear computations (in terms of table look-up or polynomial approximation). In some embodiments, the programmable engine 140 may be a very long instruction word (VLIW) processor. The programmable engine 140 may be implemented on a microprocessor chip, which may be separate from a chip implementing the fixed-function engine 150. In some embodiments, the programmable engine 140 may be a Streaming Hybrid Architecture Vector Engine (SHAVE) processor. In some embodiments, the programmable engine 140 may have an architecture optimized for the operational needs of digital signal processing. In some embodiments, the programmable engine 140 may perform some computations in a neural network operation, while other computations in the neural network operation may be performed by the fixed-function engine 150. The programmable engine 140 may support non-traditional operations or non-MatMul or non-convolution-based operations within DNNs.

In some embodiments, the programmable engine 140 may operate in accordance with compute task descriptors which may include instructions executable by the programmable engine 140. The programmable engine 140 may fetch compute task descriptors from the local memory 130 or directly from the system memory 110. The programmable engine 140 may read data (e.g., activations, weights, etc.) of an AI operator from the local memory 130 or from the system memory 110 and perform computations on the data to execute the AI operator. The programmable engine 140 may also write results of the computations into the local memory 130 or into the system memory 110.

The fixed-function engine 150 can perform specific AI operators in DNNs, e.g., MatMul operators, convolution operators, and so on. In some embodiments, the fixed-function engine 150 may execute a DNN layer by running one or more deep learning operations in the DNN layer. A fixed-function engine 150 may execute a layer, or a portion of a layer, at a time. The fixed-function engine 150 may be capable of running various types of neural network operations, such as convolution, matrix multiplication, SoftMax operation, pooling, elementwise operation, linear operation, non-linear operation, and so on. Neural network operations performed by the fixed-function engine 150 include tensor operations, i.e., operations whose inputs are tensors or operations whose outputs are tensors. In an example, the fixed-function engine 150 receives an input tensor and one or more convolutional kernels and performs a convolution with the input tensor and convolutional kernels. The result of the convolution may be an output tensor, which can be further computed, e.g., by the fixed-function engine 150 or another fixed-function engine 150.

In the embodiments of FIG. 1, the fixed-function engine 150 includes an IDU 160, a processing engine 170, a post-processing engine 180, and an ODU 190. Some or all the components of the fixed-function engine 150 can be implemented on the same chip. In other embodiments, alternative configurations, different or additional components may be included in the fixed-function engine 150. Further, functionality attributed to a component of the fixed-function engine 150 may be accomplished by a different component included in the fixed-function engine 150, a different fixed-function engine 150, another component of the NPU 101, or a different system. A component of the fixed-function engine 150 may be implemented in hardware, software, firmware, or some combination thereof.

The IDU 160 loads data from the local memory 130 to the processing engine 170 or to the post-processing engine 180. The IDU 160 may read tensors from the local memory 130. The tensors may include activation tensors, weights tensors, and so on. The IDU 160 may perform group-wise loading of activations or weights. In some embodiments, the IDU 160 may read data from the local memory 130 and write the data into storage units in the processing engine 170. For instance, the IDU 160 may load activations into activation register files in the processing engine 170 and load weights into weight register files in the processing engine 170. The IDU 160 may have an activation reader for loading activations and a weight reader for loading weights. In some embodiments, the IDU 160 may read configuration parameters from the local memory 130 and load the configuration parameters into configuration registers or other configurable components (e.g., LUTs) of the processing engine 170 or post-processing engine 180.

The processing engine 170 performs operations in DNNs. The processing engine 170 may include one or more processing cells. In some embodiments, the processing cells may be arranged in one or more rows and one or more columns in the processing engine 170. Each processing cell may include PEs that may be arranged in an array that includes rows and columns. All the PEs in the processing engine 170 may constitute a bigger array that includes more rows and columns. In some embodiments, a processing cell may have a sparsity logic unit for accelerating computations in DNNs based on data sparsity. For instance, the sparsity logic unit may obtain or generate a sparsity bitmap and use the sparsity bitmap to identify nonzero values in the activation register files or weight register files and send nonzero values to the PEs for performing computation, while zero values are skipped from being used.

An example PE may be or may include one or more multiply-accumulate (MAC) units that can perform MAC operations. In some embodiments (e.g., embodiments where the fixed-function engine 150 executes a convolutional layer), a computation in an MAC unit may be an MAC operation on an activation operand and a weight operand. The activation operand may be an activation tensor that may include one or more activations in the input tensor of the convolution. Different activations may be in different input channels. The weight operand may be a weight tensor that may include one or more weights in the filter of the convolution. The values of the weights are determined through training the DNN or compressing the neural network operation after training. The weights in the weight operand may be in different input channels. In some embodiments, the activation operand or weight operand is a vector along the input channel dimension.

In some embodiments, an MAC unit includes one or more multipliers for performing multiplications. An MAC unit may also include one or more accumulators (“adders”) for performing accumulations. An MAC unit may also include one or more shifters to facilitate mixed-precision computations. A column of MAC units is referred to as an MAC column. An MAC column may be associated with one or more MAC lanes. A MAC lane is a path for loading data e.g., by the IDU 160, into an MAC column. A MAC lane may also be referred to as a data transmission lane or data loading lane. An MAC column may have multiple MAC lanes. The loading bandwidth of the MAC column is an aggregation of the loading bandwidths of all the MAC lanes associated with the MAC column. With a certain number of MAC lanes, data can be fed into the same number of independent MAC units simultaneously. In some embodiments where an MAC column has four MAC lanes for feeding activations or weights into the MAC column and each MAC lane may have a bandwidth of 16 bytes, the four MAC lanes can have a total loading bandwidth of 64 bytes.

In some embodiments, a PE may include an output register file that stores output data of the MAC unit(s) of the PE. The output data may be transmitted 180 from the output register file to one or more other PEs in the processing engine 170 or transmitted to the post-processing engine. The output data may include partial sums or final sums computed by MAC unit(s). The output data may include output activations of the neural network operation. In some embodiments, the output register file may be a circular buffer-based output register file. The output register file may include one or more circular buffers. A circular buffer may also be referred to as ring buffer or cyclic buffer. A circular buffer may be a fixed-size data structure that uses a single, contiguous block of memory as if it were connected end-to-end in a loop. The circular buffer may manage data in a first-in, first-out (FIFO) manner without needing to move elements when new data is added or old data is removed.

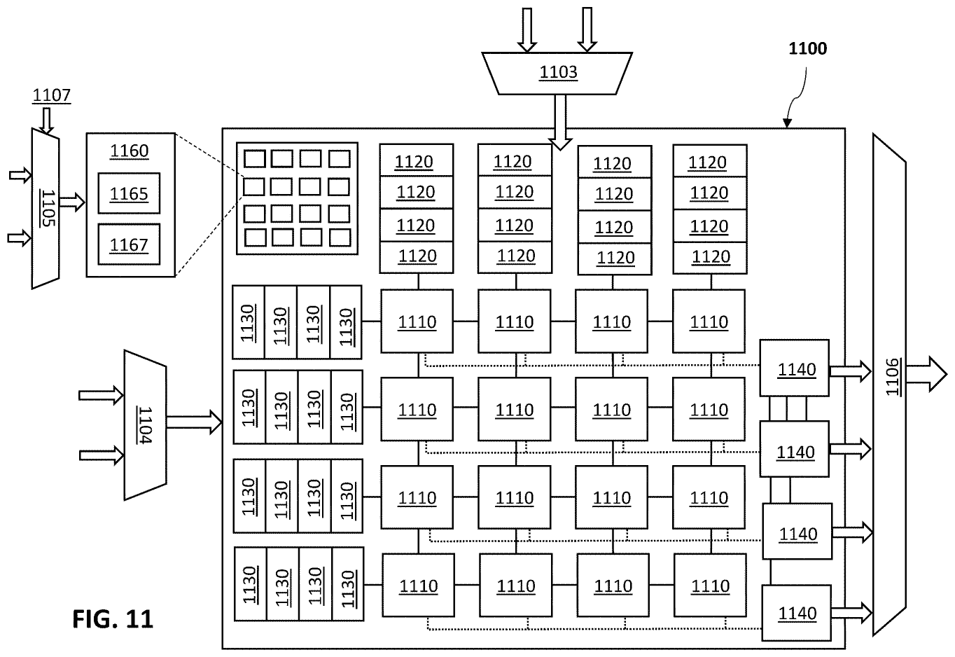

In some embodiments, the processing engine 170 may include one or more processing cells. A processing cell may include an MAC array. In embodiments where the processing engine 170 has multiple processing cells, the processing cells may be arranged in one or more rows or one or more columns to form a larger array. In some embodiments, the processing engine 170 may include different types of MAC arrays. For instance, the processing engine 170 may include one or more sparse cell arrays, one or more CiM arrays, other types of MAC arrays, or some combination thereof. Certain aspects regarding the processing engine are described below in conjunction with FIGS. 11-13.

The post-processing engine 180 may process outputs of the processing engine 170. The post-processing engine 180 may include one or more post-processing elements (PPEs). In some embodiments, the PPEs in the post-processing engine 180 may be arranged in an array that has rows and columns. In some embodiments, the post-processing engine 180 computes activation functions. The post-processing engine 180 may receive outputs of the processing engine 170 as inputs to the activation functions. In addition or alternative to activation functions, the post-processing engine 180 may perform other types of post processing on outputs of the processing engine 170, such as quantization, dequantization, and so on. In an example, the post-processing engine 180 may apply a bias on an output of the processing engine 170. In another example, the post-processing engine 180 may apply a scale or zero point on an output of the processing engine 170 to quantize or dequantize the output of the processing engine 170. In some embodiments, the post-processing engine 180 may be bypassed for certain neural network operations.

The ODU 190 drains data from the processing engine 170 or from the post-processing engine 180, e.g., from register files in the processing engine 170 or from the post-processing engine 180. The drain module may write the data to the local memory 130. The drained data may be tensors, such as output tensors of neural network operations. In some embodiments, the ODU 190 may drain data on a cell level. For each processing cell, the ODU 190 may drain outputs of PEs in the processing cell based on a row index or column index of each PE. For instance, the ODU 190 may use a sequence of cycles to drain data from a processing cell. The ODU 190 may drain the output of some of the PEs in each cycle. The sequence of the cycles may be configured based on a configuration parameter indicating the operation mode of the IDU 160.

In some embodiments, the ODU 190 includes sparsity encoding logic that can convert outputs of the processing engine 170 from a dense format to a sparse format. For instance, the ODU 190 may be implemented with one or more sparsity encoders. A sparsity encoder converts dense data to compressed data based on sparsity in the dense data. For instance, the sparsity encoder may remove zeros from data computed by the processing engine 170. The sparsity encoder may also generate sparsity maps that represent sparsity in the dense data. A sparsity map may be a sparsity bitmap, in which each bit may correspond to a data point and indicate whether the data point is zero or not.

In some embodiments, the data drained from the processing engine 170 may be output data elements of a DNN layer. The sparsity encoder may generate a compressed version of the output tensor. The sparsity encoder may identify every zero activation in the output tensor and remove these activations from the output tensor to generate a compressed activation tensor (aka “sparse activation tensor”). The sparsity encoder may also generate one or more sparsity maps for the output tensor. A sparsity map may indicate sparsity in at least part of the output tensor. The sparsity map may include sparsity elements (e.g., bits), each of which corresponds to a different activation in the vector and indicates whether the corresponding activation is zeroed or not.

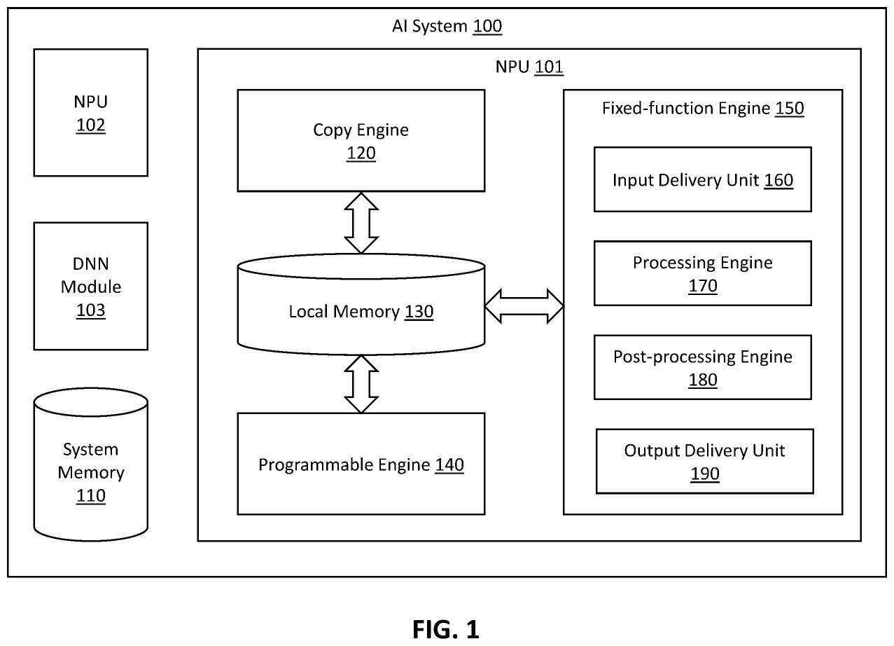

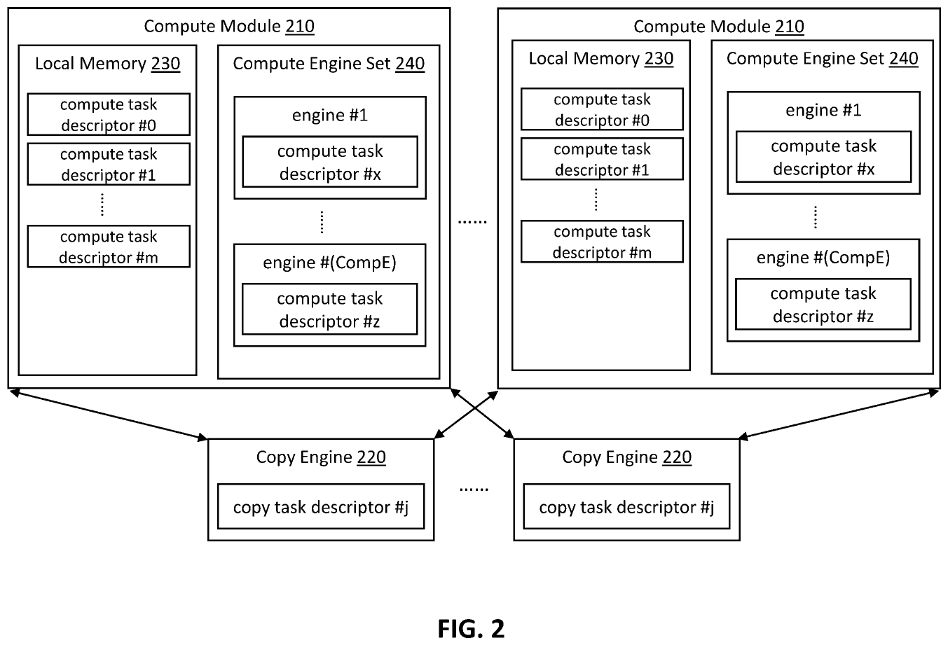

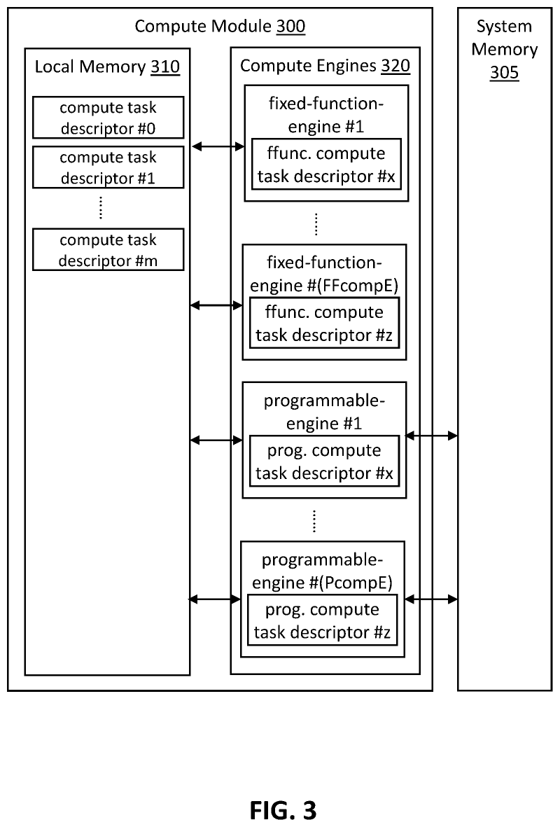

The programmable engine 140 and fixed-function engine 150 can be collectively referred to as compute engines. The programmable engine 140 and fixed-function engine 150 may be two different types of compute engines. Even though not shown in FIG. 1, the NPU 101 may include other types of compute engines. The compute engines in the NPU 101 may perform computations in DNNs based on compute task descriptors, such as compute task descriptors generated by the DNN module 103 or stored in the system memory 110. In some embodiments, the local memory 130, programmable engine 140, and fixed-function engine 150 may be inside a compute module, while the copy engine 120 may be outside the compute module. The NPU 101 may include multiple compute modules and multiple copy engines. Certain aspects regarding compute module and copy engine are described below in conjunction with FIG. 2 and FIG. 3.

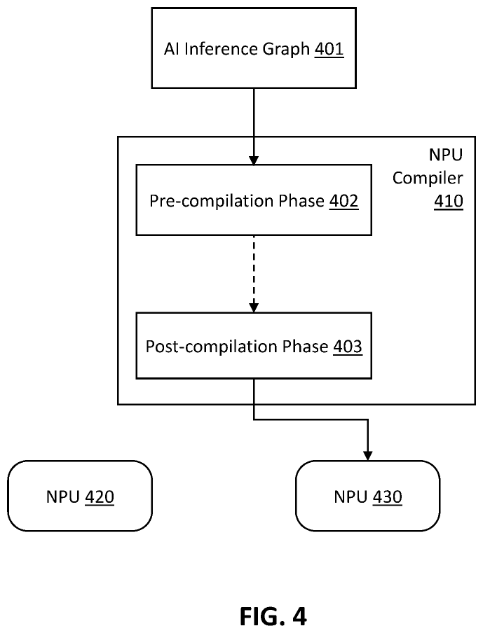

The NPU 102 may have a different hardware configuration from the NPU 101. For example, the NPU 102 may have a local memory whose storage capacity is different from the storage capacity of the local memory 130. As another example, the NPU 102 may have fewer or more copy engines, compute modules, or compute engines than the NPU 101. In some embodiments, the AI system 100 may include a single NPU. For instance, the AI system 100 may include the NPU 101 but not the NPU 102. The DNN module 103 may compile DNN models based on the configuration of the NPU 102 even though the NPU 102 is not present in the AI system 100. The DNN module 103 may further translate the result of the compilation (e.g., a binary asset) based on the configuration of the NPU 101 so that the binary asset can be used by the NPU 101 to execute the DNN models. Certain aspects regarding compilation based on different NPU configurations are described below in conjunction with FIGS. 4-6.

FIG. 2 illustrates a configurable NPU architecture, in accordance with various embodiments. The NPU may be an AI accelerator integrated into several computation devices to more efficiently handle AI workloads. The NPU design is configurable. For illustration, FIG. 2 shows compute modules 210 (individually referred to as “compute module 210”) and copy engines 220 (individually referred to as “copy engine 220”). Each compute module 210 includes a local memory 230 (plurally referred to as “local memories 230”) and a compute engine set 240 (plurally referred to as “compute engine sets 240”). Each compute engine set 240 includes CompE compute engines, shown as engine #1 through engine #(CompE) in FIG. 2. Examples of the compute engines include the programmable engine 140 or the fixed-function engine 150 in FIG. 1. An example of the copy engines 220 is the copy engine 120 in FIG. 1. An example of the local memories 230 is the local memory 130 in FIG. 1.

In the embodiments of FIG. 2, each compute engine may perform a compute task in accordance with a “compute task descriptor.” In some embodiments, a compute task descriptor is a data structure or configuration that contains metadata or parameters needed to define, manage, and execute a specific computational task. A compute task descriptor for DNN execution may include metadata or parameters that the compute engine may use to execute one or more computations in a DNN. For instance, the compute task descriptor may specify computation type (e.g., multiplication, addition, shifting, etc.), input data information (e.g., data type, data size, storage location, etc.), output data information, data format (e.g., data type, data size, storage location, etc.), state of the task (e.g., pending, running, complete, etc.), dependencies on other compute tasks (e.g., the compute task needs to be performed before or after another task), and so on. Additionally or alternatively, the compute task descriptor may include precomputed data that the compute engine may use to execute a neural network operation. For instance, the compute task descriptor may include precomputed data that can be stored in a look-up table in the compute engine for the compute engine to perform a neural network operation (e.g., an activation function). The precomputed data may be output values of the neural network operation. Compute task descriptors may be used to program registers (e.g., control and status registers) in the compute engine.

Compute task descriptors can be generated by an NPU workload compiler and copied into the local memories 230 by the copy engines 220. The copy engines 220 sit outside of the compute modules 210. A copy engine 220 can be responsible for the movement of data between the local memory in a compute module 210 and a system memory (not shown in FIG. 2). The copy engine 220 may perform a data movement task in accordance with a copy task descriptor. The data movement task may be a task of moving data between a local memory 230 and the system memory. Data moved by the copy engines 220 may be input data of neural network operations, intermediate data of neural network operations, output data of neural network operations, or compute task descriptors. Compute task descriptors or copy task descriptors may be generated by a compiler. The number of compute modules 210 (CM), the number of copy engines 220 (CopyE), and the number of compute engines in each compute engine set 240 (CompE) may be hardware configuration that can differ for different NPUs, e.g., different NPU generations. The NPU compiler can be aware of the hardware configuration {CM,CompE,CopyE} and create a list of task descriptors for each compute engine and each copy engine 220. For a given hardware configuration, a static mapping of task to engine can be created in the schedule generated by the compiler.

FIG. 3 illustrates a compute module 300, in accordance with various embodiments. The compute module 300 is coupled with a system memory 305. An example of the system memory 305 is the system memory 110 in FIG. 1.

The compute module 300 includes a local memory 310. The size of the local memory may be defined as LM. An example of the local memory 310 is the local memory 130 in FIG. 1.

The compute module 300 also includes compute engines 320 coupled with the local memory 310. The compute engines 320 include two types of compute engines: fixed-function engines and programmable engines. The fixed-function engines can perform specific common AI operators such as convolutions, general matrix multiplication, and so on. They can access the local memory 310. They may not be able to access the system memory 305 directly. For instance, data to be processed by the fixed-function engines can be moved from the system memory 305 into the local memory 310 by a copy engine. Also, data computed by the fixed-function engines can be moved from the local memory 310 into the system memory 305 by the copy engine.

The programmable engines may be general-purpose programmable engines. The programmable engines can execute instructions, such as instruction sets. The programmable engines can adhere to an instruction set architecture (ISA), such as a strict, stable ISA. The programmable engines can execute AI operators written as software kernels. These kernels may be written in a high-level programming language, such as C/C++ or similar high-level languages. The programmable engines can directly access both the local memory 310 and the system memory 305. All fixed-function operators baked in the hardware engines can be implemented as a software kernel that executes on the programmable engines. This can provide flexibility in the NPU hardware/software gen-on-gen design, where legacy features can be emulated and mapped to the programmable engines. For instance, because of their flexibility and memory reach, the programmable engines can serve as the universal emulation layer in the post-compilation phase. They can also provide a fallback mechanism for the entire binary translation scheme. They can host local memory staging in the system memory 305 when the new hardware has less local memory (cLM<LM). They can absorb emulated compute modules when the new hardware has fewer modules (cCM<CM).

FIG. 4 illustrates two-phase NPU compilation, in accordance with various embodiments. The two-phase NPU compilation is performed by an NPU compiler 410. In some embodiments, the NPU compiler 410 can perform NPU compilation by ingesting an AI inference model to produce a set of task descriptors for the compute engines and copy engines of the NPU hardware. FIG. 4 shows an example in which the NPU compiler 410 compiles a DNN model using an AI inference graph 401. The NPU compiler 410 can use the AI inference graph 401 to generate compute task descriptors and copy task descriptors. The AI inference graph 401 may be a graph representing a DNN model. The graph may include nodes and edges connecting the nodes. A node may represent an AI operator, such as a MatMul operator, and so on. An edge may represent data flow between two AI operators.

In the illustrated example, the two-phase NPU compilation includes two distinct chronological phases: a pre-compilation phase 402 and a post-compilation phase 403. The pre-compilation phase 402 may be conducted before the post-compilation phase 403. The two phases are conducted targeting two NPUs (an NPU 420 and an NPU 430), respectively. The NPU 420 and NPU 430 may be two different types of NPUs and may have different hardware configurations. For instance, the NPU 420 and NPU 430 may have different numbers of compute modules, compute engines, copy engines, or local memory size.

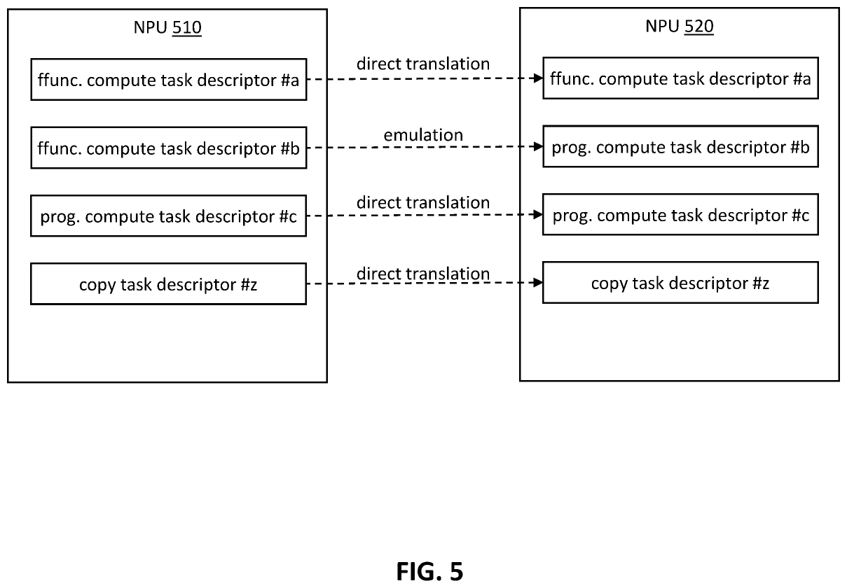

The NPU compiler 410 performs the pre-compilation phase 402, targeting the hardware configuration of the NPU 420. This NPU pre-compilation phase 402 can produce a pre-compiled binary asset tailored to the hardware configuration of the NPU 420. The binary asset may include data structures that encode the list of tasks for deployment to the NPU 420. For instance, the NPU compiler 410 may generate compute task descriptors and copy task descriptors that can be executed by the NPU 420. The compute task descriptors and copy task descriptors may not be executable by the NPU 430. At the later stage, the post-compilation phase 403 takes the pre-compiled binary asset and targets the hardware configuration of the NPU 430. For instance, the NPU compiler 410 may translate the binary asset and generate a new binary asset specific to the hardware configuration of the NPU 430. The new binary asset may include compute task descriptors and copy task descriptors that can be executed by the NPU 430. The new binary asset can be accessed and used by the NPU 430 to execute the DNN model. In some embodiments, the NPU compiler 410 may store the compute task descriptors in a system memory. One or more copy engines can move the compute task descriptors from the system memory to a local memory of the NPU 430 in accordance with the copy task descriptors. Certain aspects regarding task descriptor translation are described below in conjunction with FIG. 5. Certain aspects regarding NPU compiler are described below in conjunction with FIG. 7.

FIG. 5 illustrates task descriptor translations, in accordance with various embodiments. The task descriptor translations may be performed by an NPU compiler in a post-compilation phase, e.g., the post-compilation phase 403 described above in conjunction with FIG. 4. The NPU post-compilation phase seeks to translate the task descriptors from the pre-compiled binary for targeting another NPU hardware generation. In the embodiments of FIG. 5, the task descriptor translations are translations from task descriptors for an NPU 510 to task descriptors for an NPU 520. The task descriptors for the NPU 510 may be generated in a pre-compilation phase based on the hardware configuration of the NPU 510. The task descriptor translations may be performed based on the hardware configuration of the NPU 510 and the hardware configuration of the NPU 520. As an example, FIG. 5 shows four permutations of task descriptor translation given the pre-compiled binary asset that was compiled for the hardware configuration of the NPU 510. The deployment target is the hardware configuration of the NPU 520. In the illustrated example, the NPU 510 includes two fixed-function engines and a programmable engine.

The first permutation is a direct translation. A fixed-function engine of the NPU 510 has a corresponding task descriptor “ffunc. compute task descriptor #a” that can be directly translated into the NPU 520 when there is hardware support for the encoded operator.

The second permutation is an emulation. When a fixed-function operator in the NPU 510 is not supported in the NPU 520, a programmable engine task is created to emulate the missing functionality. The second permutation is a translation of “ffunc. compute task descriptor #b” to “prog. compute task descriptor #b”. The programmable task “prog. compute task descriptor #b” has a software kernel implementation that emulates the original operator encoded in “ffunc. compute task descriptor #b”. Programmable tasks in the NPU 510 can be mapped to the NPU 520 as binary compatibility can be guaranteed by design for the pre-compiled software kernels. The general-purpose programmable engines across different NPU configurations can adhere to a strict instruction set architecture (ISA). Software kernels compiled for a specific NPU configuration can be executed on one or more other NPU configurations.

The third permutation is another direct translation. A programmable engine of the NPU 510 has a corresponding task descriptor “prog. compute task descriptor #c” that can be directly translated into the NPU 520 when there is hardware support for the encoded operator.

The fourth permutation is a direct translation of a copy task descriptor. A copy engine of the NPU 510 has a corresponding task descriptor “copy task descriptor #z” that can be directly translated into the NPU 520 when there is hardware support for the copy operator. In some embodiments, the copy engine task descriptors may be trivial to translate across NPU configurations. Copy engines can move data from a source to a destination using an affine transformation. This affine transformation can be encoded in various NPU configurations of the “copy task descriptor”.

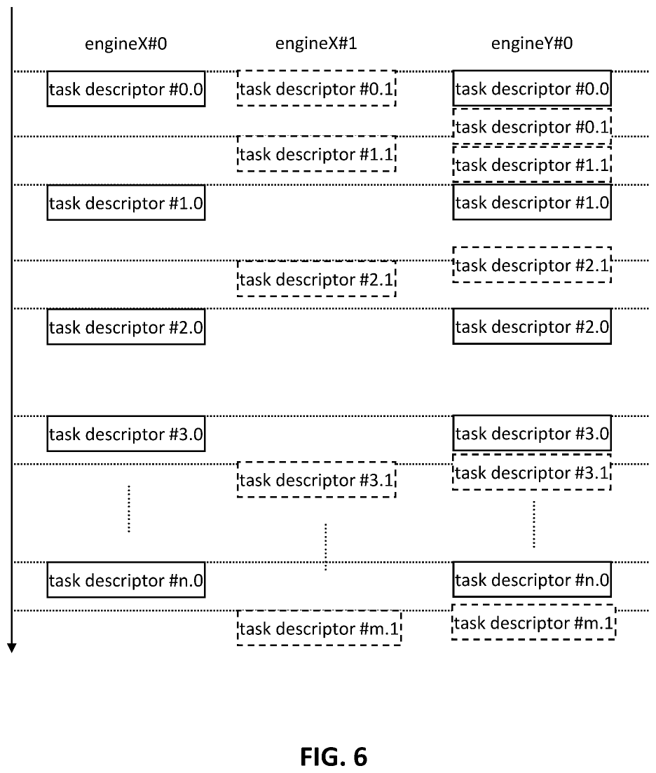

FIG. 6 illustrates task descriptors for NPUs with different configurations, in accordance with various embodiments. For illustration, FIG. 6 shows an example in which NPU X has more compute engines and copy engines than NPU Y. The hardware configuration of NPU X may be characterized by design hyperparameters {CM,CompE,CopyE,LM}; and the hardware configuration of NPU Y may be characterized by design hyperparameters {cCM,cCompE,cCopyE,cLM}. In an example where a compiler performs pre-compilation based on the hardware configuration of NPU X and the deployment target is NPU Y, the hardware configuration of NPU X may be referred to as “pre-compilation NPU configuration” and the hardware configuration of NPU Y may be referred to as “post-compilation NPU configuration”.

In an example where cLM<LM, the pre-compiled tasks in the pre-compilation NPU configuration have a larger local memory. The programmable engines can be used to direct access to the system memory. The local memory staging area may be hosted in the system memory, where every fixed-function task “ffunc. compute descriptor” may be converted to a programmable task “prog. compute descriptor”. This step may be needed when the fixed-function engines in the compute modules cannot access system memory. The copy engines have access to the system memory, so all their original interactions with the local memory can be re-directed to the staging area allocated in the system memory.

In an example where cLM>=LM, it may be trivial for remapping the pre-compiled resources of the pre-compilation NPU configuration to the post-compilation NPU configuration. The local memory and fixed-function engines in the post-compilation NPU configuration can be used natively when other requirements are satisfied.

When there are fewer compute engines or copy engines in the post-compilation NPU configuration (cCompE<CompE or cCopyE<CopyE), the affected task lists can be serialized and merged based on execution order. FIG. 6 shows an example of the pre-compilation NPU configuration having more engines (compute/copy) than the post-compilation NPU configuration. The pre-compilation NPU configuration has engineX #0 and engineX #1, where each engine has task lists “task descriptor #(0-n).0” and “task descriptor #(0-m).1” respectively. In the post-compilation phase, information can be available on the execution order for each task in both lists for engineX #0 and engineX #1. Both task lists can be serialized and merged into a single list for NPU generation Y, engineY #0 shown on the right of FIG. 6. The post-compilation can merge pre-compiled compute/copy engine task lists when needed.

When the post-compilation NPU configuration has more engines than the pre-compilation NPU configuration, the merger of task lists can be bypassed in the post-compilation phase. When there are fewer compute modules in the post-compilation NPU configuration compared to the pre-compilation NPU configuration (cCM<CM), the deficit compute modules (CM−cCM) may be emulated using the existing programmable engines and system memory allocations for local memory staging. The existing task lists for the programmable engines in all the cCM may be merged based on execution order with the emulated task lists. When cCM>=CM, the mapping of resources from the pre-compilation NPU configuration to the post-compilation NPU configuration can be trivial for the NPU post-compilation phase.

FIG. 7 is a block diagram of a DNN module 700, in accordance with various embodiments. The DNN module 700 may train and compile DNN models for performing AI tasks. An AI task can be performed through AI inference. The DNN module 700 may be an example of the DNN module 103 in FIG. 1. As shown in FIG. 7, the DNN module 700 includes an interface module 710, a training module 720, a compiler 730, and a datastore 740. In other embodiments, alternative configurations, different or additional components may be included in the DNN module 700. Further, functionality attributed to a component of the DNN module 700 may be accomplished by a different component included in the DNN module 700 or a different module or system.

The interface module 710 facilitates communications of the DNN module 700 with other modules or systems. For example, the interface module 710 establishes communications between the DNN module 700 with an external database to receive data that can be used to train DNNs or input into DNNs to perform tasks. As another example, the interface module 710 may distribute trained DNNs to other systems, e.g., computing devices configured to apply DNNs to perform tasks.

The training module 720 trains DNNs by using a training dataset. The training module 720 forms the training dataset. In an example where the training module 720 trains a DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the training module 720 to validate performance of a trained DNN. The data portion of the training dataset not including the tuning subset and the validation subset may be used to train the DNN.

The training module 720 also determines hyperparameters for training the DNN.

Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 5, 10, 50, 100, 500, 1000, or even larger.

The training module 720 defines the architecture of the DNN, e.g., based on some of the hyperparameters. The architecture of the DNN includes an input layer, an output layer, and a plurality of hidden layers. The input layer of a DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input image. The hidden layers are layers between the input layer and output layer. The hidden layers include one or more convolutional layers and one or more other types of layers, such as pooling layers, fully-connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of the input image after convolution. It is used between two convolutional layers. A fully-connected layer involves weights, biases, and neurons. It connects neurons in one layer to neurons in another layer. It is used to classify images between different categories by training.

In the process of defining the architecture of the DNN, the training module 720 also adds an activation function to a hidden layer or the output layer. An activation function of a layer transforms the weighted sum of the input of the layer to an output of the layer. The activation function may be, for example, a ReLU activation function, a tangent activation function, or other types of activation functions.

After the training module 720 defines the architecture of the DNN, the training module 720 inputs a training dataset into the DNN. The training dataset includes a plurality of training samples. An example of a training sample includes an object in an image and a ground-truth label of the object. The training module 720 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 720 uses a cost function to minimize the error.

The training module 720 may train the DNN for a predetermined number of epochs. The number of epochs is a hyperparameter that defines the number of times that the deep learning algorithm works through the entire training dataset. One epoch means that each sample in the training dataset has had an opportunity to update internal parameters of the DNN. After the training module 720 finishes the predetermined number of epochs, the training module 720 may stop updating the parameters in the DNN. The DNN having the updated parameters is referred to as a trained DNN.

The training module 720 may also verify accuracy of DNNs after training. In some embodiments, the training module 720 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the training module 720 may determine an accuracy score measuring the precision, recall, or a combination of precision and recall of the DNN. The training module 720 may use the following metrics to determine the accuracy score: Precision=TP/(TP+FP) and Recall=TP/(TP+FN), where precision may be how many the DNN correctly predicted (TP or true positives) out of the total it predicted (TP+FP or false positives), and recall may be how many the DNN correctly predicted (TP) out of the total number of objects that did have the property in question (TP+FN or false negatives). The F-score (F-score=2*PR/(P+R)) unifies precision and recall into a single measure.

The training module 720 may compare the accuracy score with a threshold score. In an example where the training module 720 determines that the accuracy score of the DNN is less than the threshold score, the training module 720 instructs the training module 720 to re-train the DNN. In one embodiment, the training module 720 may iteratively re-train the DNN until the occurrence of a stopping condition, such as the accuracy measurement indicating that the DNN may be sufficiently accurate, or a number of training rounds having taken place.

The compiler 730 compiles DNNs to generate instructions that can be executed by NPUs, including the NPUs described above, to carry out neural network operations in DNNs. In some embodiments, the compiler 730 may generate a graph representing a DNN. The graph may include nodes and edges. A node may represent a specific AI operator in the DNN. An edge may connect two nodes and represent a connection between the two corresponding AI operators. In an example, an edge may encode a tensor that flows from one of the AI operators to the other AI operator. The tensor may be an output tensor of the first AI operator and an input tensor of the second AI operator. The edge may encode one or more attributes of the tensor, such as size, shape, storage format, and so on.

The compiler 730 may use the graph to generate configuration parameters that can configure components of the NPU for executing the DNN. In some embodiments, the configuration parameters include descriptors, such as compute task descriptors and copy task descriptors. For instance, the compiler 730 may generate a list of tasks for one or more compute engines in the NPU to perform for a given DNN workload. The items in the list may be compute task descriptors, which may include instructions or information that the compute engine(s) can use to carry out the tasks. For instance, a compute task descriptor may define the type of computation, data precision, memory address where data is stored, and so on. The compiler 730 may also create a list of tasks for one or more copy engines in the NPU. The items in this list may be copy task descriptors, such as auto-fetch descriptors. The copy engine may fetch data (e.g., compute task descriptors) from a system memory to a local memory of the NPU based on the copy task descriptors. The compiler 730 may write both lists into the system memory. In some embodiments, compute task descriptors may be grouped into compute descriptor groups. Each compute descriptor group may have a corresponding auto-fetch descriptor, based on which the copy engine may fetch the compute descriptor group from the system memory to the local memory.

In some embodiments, the compiler 730 may perform two-phase compilation: a pre-compilation phase and a post-compilation phase. The compiler 730 may target different NPU configurations in the two phases. For instance, the compiler 730 may generate a set of compute task descriptors and copy task descriptors in the pre-compilation phase. The compute task descriptors and copy task descriptors may be data structures that encode AI inference tasks for deployment to hardware with NPU configuration X. The AI inference tasks may be tasks of executing AI operators of the DNN model. The tasks may have an order, which may match the execution order of the AI operators in the architecture of the DNN model.

In the post-compilation phase, the compiler 730 may translate the compute task descriptors and copy task descriptors generated in the pre-compilation phase to new compute task descriptors and copy task descriptors. The new compute task descriptors and copy task descriptors may be data structures that encode the AI inference tasks for deployment to hardware with NPU configuration Y, which is different from NPU configuration X. The compiler 730 can translate binary asset targeting NPU configuration X to binary asset targeting NPU configuration Y in the post-compilation phase.

The compiler 730 may perform task descriptor translations based on NPU configuration X and NPU configuration Y. For instance, the compiler 730 may compare design hyperparameters that define the two NPU configurations. The design hyperparameters may include the number of compute modules (CM), the number of compute engines (CompE) in each compute module, the number of copy engines (CopyE), and the storage size of the NPU's local memory (LM). The compiler 730 may translate task descriptors based on the comparison of one or more design hyperparameters of NPU configuration X with the corresponding design hyperparameter(s) of NPU configuration Y. In an example, when LM of NPU configuration X is larger than LM of NPU configuration Y, the compiler 730 may translate a compute task descriptor for a fixed-function engine of NPU configuration X to a compute task descriptor for a programmable engine of NPU configuration Y. The fixed-function engine has access to the local memory but has no access to the system memory. The programmable engine can have access to both memories. When LM of NPU configuration X is smaller than or equal to LM of NPU configuration Y, the compiler 730 may directly translate a compute task descriptor for a fixed-function engine of NPU configuration X to a compute task descriptor for a fixed-function engine of NPU configuration Y. In another example, when NPU configuration Y has a smaller CompE or CopyE than NPU configuration X, the compiler 730 can combine the task lists for multiple compute engines into a single task list. For instance, the compiler 730 can serialize and merge all the task descriptors in these task lists generated for NPU configuration X to generate a single task list for NPU configuration Y. The order of the tasks in the single task list can match the execution order of the corresponding AI operators. When NPU configuration Y has a larger CompE or CopyE than NPU configuration X, the compiler 730 may bypass the task list combination process.

After the two-phase compilation completes, the compiler 730 may store the final binary asset of the two-phase compilation in a system memory. The system memory may be placed outside the NPU with configuration Y. A copy engine of the NPU may move compute task descriptors from the system memory to a local memory of the NPU based on one or more copy task descriptors. The compute engines of the NPU may execute AI operators in accordance with the compute task descriptors. The copy engine may also move activations or weights used or generated by the compute engines between the system memory and the local memory.

In some embodiments, the compiler 730 may use the binary asset generated from a single pre-compilation process to perform multiple post-compilation processes. For instance, the compiler 730 may compile a DNN model and generate task descriptors for NPU configuration X and translate these task descriptors to task descriptors for NPU configuration Y, task descriptors for NPU configuration Z, and so on.

The datastore 740 stores data received, generated, used, or otherwise associated with the DNN module 700. For example, the datastore 740 stores the datasets used by the training module 720. The datastore 740 may also store data generated by the training module 720, such as the hyperparameters for training DNNs, internal parameters of trained DNNs (e.g., weights, etc.), and so on. The datastore 740 may store descriptors, binary files, computer program instructions, or other data generated by the compiler 730. The datastore 740 may include one or more memories. In the embodiment of FIG. 7, the datastore 740 is a component of the DNN module 700. In other embodiments, the datastore 740 may be external to the DNN module 700 and communicate with the DNN module 700 through a network.

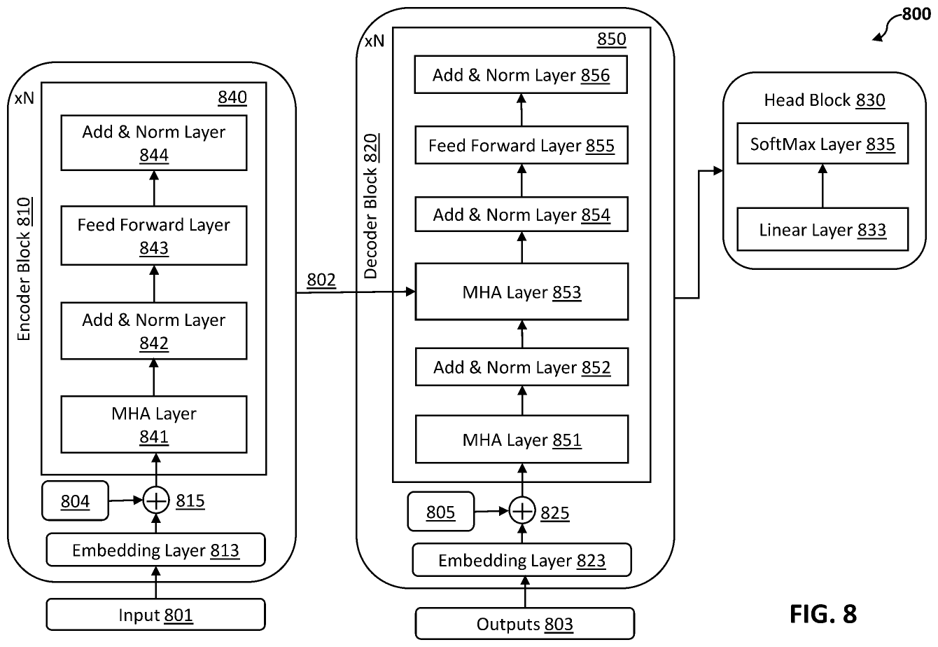

FIG. 8 illustrates an example transformer model 800, in accordance with various embodiments. The transformer model 800 is an example of the DNNs described above. The transformer model 800 may transform input sequences into output sequences. In some embodiments, the transformer model 800 is a DNN that can learn context and meaning by tracking relationships in sequential data, such as sequential words in a sentence, sequential audio signals, sequential images, and so on. In an example, the transformer model 800 may be at least part of an LLM. The transformer model 800 may be an example of the DNNs described above. As shown in FIG. 8, the transformer model 800 includes an encoder block 810, a decoder block 820, and a head block 830. In other embodiments, different or additional components may be included in the transformer model 800. Further, functionality attributed to a component of the transformer model 800 may be accomplished by a different component included in the transformer model 800 or a different model or module.

The encoder block 810 receives input sequences and generates matrix representations of the input sequences. In the embodiments of FIG. 8, the encoder block 810 receives an input 801 and generates an encoder output 802. The input 801 may be an input prompt. In some embodiments, the input 801 may include one or more input tokens, such as words, phrases, sentences, images, audio signals, other types of input tokens, or some combination thereof. In an example, the input 801 may include a prompt received from a user of the transformer model 800. The prompt may include a question or request made by the user. A word in the prompt may be an input token. The encoder output 802 may include one or more vectors that are contextualized representations of the input 801. Each vector in the encoder output 802 may represent a token in the input 801 with contextual understanding.

The encoder block 810 includes an embedding layer 813, a positional encoding layer 815, and a plurality of layers 840 (individually referred to as “layer 840”). In other embodiments, the encoder block 810 may have different, fewer, or more components. Also, the arrangement of the components in the encoder block 810 may be different from the arrangement shown in FIG. 8. For illustration, the encoder block 810 has N layers in FIG. 8, where N is an integer. Each layer 840 may include one or more neural network operations. The layers 840 may transform a sequence of embeddings into a representation that encapsulates the learned information from the input 801. Different layers 840 may have different internal parameters, e.g., different weights, bias, or other types of internal parameters. In some embodiments, the layers 840 have identical components. The components in a layer 840 may be layers and may also be referred to as sub-layers of the layer 840. As shown in FIG. 8, a layer 840 includes four sub-layers: a multi-head attention (MHA) layer 841, an add & norm layer 842, a feed forward layer 843, and another add & norm layer 844.

The decoder block 820 iteratively generates outputs 803 using encoded representations generated by the encoder block 810. The decoder block 820 includes an embedding layer 823, a positional encoding layer 825, and a plurality of layers 850 (individually referred to as “layer 850”). For illustration, the decoder block 820 has N layers in FIG. 8, where N is an integer. In the embodiments of FIG. 8, the number of layers 850 in the decoder block 820 is the same as the number of layers 840 in the encoder block 810. In other embodiments, the number of layers 850 in the decoder block 820 may be different from the number of layers 840 in the encoder block 810. Each layer 850 may include one or more neural network operations. Different layers 850 may have different internal parameters. In some embodiments, the layers 850 may have identical components. The components in a layer 850 may be layers and may also be referred to as sub-layers of the layer 850. As shown in FIG. 8, a layer 850 includes six sub-layers: an MHA layer 851, an add & norm layer 852, another MHA layer 853, another add & norm layer 854, a feed forward layer 855, and another add & norm layer 856.

In some embodiments, a sequence of inference stages is performed in the decoder block 820 using encoder outputs, e.g., the encoder output 802. A matrix may be predicted through each inference stage. The outputs 803 may include a plurality of matrices. Each matrix may be further processed in the head block 830 to predict a token. The plurality of matrices may be used to predict a sequence of tokens. For the first inference stage, the decoder block 820 may receive one or more start tokens as input tokens and compute a first matrix from the input tokens and the output of the encoder block 810. The first matrix may be used by the head block 830 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 830 receives the output of the decoder block 820 and processes it in a linear layer 833 and a Softmax layer 835. A linear operation may be performed on the output of the decoder block 820 in the linear layer 833. The linear operation may include a multiplication of the output of the decoder block 820 with a weight matrix. The output of the linear layer 833 may be a vector. In some embodiments, the head block 830 may function as a classifier. The number of data elements in the vector computed in the linear layer 833 may depend on the number of classes involved. In an example where there are M classes, where M is an integer, the vector computed in the linear layer 833 may have M data elements representing the prediction for the M classes, respectively.

The output of the linear layer 833 may be input into the Softmax layer 835. A Softmax function may be applied on the output of the linear layer 833 to compute probability scores. A probability score may have a value in the range from 0 to 1. In some embodiments, a probability value is computed for each data element in the vector computed in the linear layer 833. The highest one of the probability scores may be the key. The corresponding index of the key may point to the token that the transformer model 800 predicts as the next in the sequence. The final output of the transformer model 800 may be the sequence of predicted tokens. In some embodiments, the head block 830 may be a language modeling head.

An embedding layer (e.g., the embedding layer 813 or the embedding layer 823) converts an input of the embedding layer (e.g., the input 801 or the outputs 803) into one or more embeddings. An embedding may be a vector, which is also referred to as an embedding vector or a vector embedding. The vector embedding may include a sequence of data elements. In some embodiments, the embedding layer 813 may generate a plurality of embeddings, each of which may be converted from a different input token in the input 801. The embeddings may capture the semantic meaning of the tokens in the input 801. The embeddings may be numerical representations that capture the relationships or meanings of words, phrases, or other data types. In an example where the input 801 is a prompt including a sequence of words, the embedding layer 813 may generate an embedding from each word in the input 801. The embedding layer 823 in the decoder block 820 may generate a plurality of embeddings from tokens received by the decoder block 820 in a similar manner as the embedding layer 813.

A positional encoding layer (e.g., the positional encoding layer 815 or the positional encoding layer 825) performs positional encoding on embeddings generated in the corresponding embedding layer. In some embodiments, the positional encoding layer may apply one or more positional encoding vectors (e.g., a positional encoding vector 804 or positional encoding vector 805) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 841, the MHA layer 851, or the MHA layer 853) may implement a multi-head attention mechanism, which may be a multi-head self-attention mechanism or a multi-head cross-attention mechanism. In some embodiments, the MHA layer 841 or the MHA layer 851 may implement a self-attention mechanism. For self-attention, the queries, keys, and values may come from the same place. For instance, for the MHA layer 841, the queries, keys, and values may all come from the positional encoding layer 815. For the MHA layer 851, the queries, keys, and values may all come from the positional encoding layer 825. The self-attention mechanism may enable the transformer model 800 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 841 may be computed from vector embeddings generated by the positional encoding layer 815. The queries, keys, and values input into the MHA layer 851 may be computed from vector embeddings generated by the positional encoding layer 825. A query, key, or value may be a vector that represents a token in a sequence. In some embodiments, a query matrix Q∈ [symbol] ^{N×h} may be computed by multiplying an embedding matrix X∈ [symbol] ^{N×d} (e.g., an embedding matrix computed in a positional encoding layer) with a weight matrix W_{q}∈ [symbol] ^{d×h}, where d is the dimension of a vector embedding, N is the number of vector embeddings in the embedding matrix, and h is the number of attention heads. Each row in the query matrix may be a query. A key matrix K∈ [symbol] ^{N×h} may be computed by multiplying an embedding matrix X∈ [symbol] ^{N×d} (e.g., an embedding matrix computed in a positional encoding layer) with a weight matrix W [symbol] ∈ [symbol] ^{d×h}. Each row in the key matrix may be a key. A value matrix V∈ [symbol] ^{N×h} may be computed by multiplying an embedding matrix X∈ [symbol] ^{N×d} (e.g., an embedding matrix computed in a positional encoding layer) with a weight matrix Wᵥ∈ [symbol] ^{d×h}. Each row in the value matrix may be a value.

In some embodiments, the MHA layer 851 may implement masked multi-head self-attention. The MHA layer 851 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 853 may implement a cross-attention mechanism, such as encoder-decoder cross-attention. The MHA layer 853 may use outputs from the previous layer (i.e., the add & norm layer 852) as queries and use outputs from the encoder block 810 as keys and values. The cross-attention can align the encoder's input with the decoder's, empowering the decoder block 820 to identify and emphasize the most relevant parts of the encoder's input.

In some embodiments, an MHA layer includes linear layers, a MatMul layer, a scale layer, a Softmax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as

$${QW}_{i}^{Q} ,$$

where Q is the query matrix and

$${W}_{i}^{Q} ∈ {ℝ}^{{d}_{model} \times {d}_{q}}$$

is the wight matrix. A second linear layer may perform a multiplication of the key matrix with a weight matrix to compute a second parameter matrix. The second parameter matrix may be denoted as

$${KW}_{i}^{K} ,$$

where K is the key matrix and

$${W}_{i}^{K} ∈ {ℝ}^{{d}_{model} \times {d}_{k}}$$

is the weight matrix. A third linear layer may perform a multiplication of the value matrix with a weight matrix to compute a third parameter matrix. The third parameter matrix may be denoted as

$${VW}_{i}^{V} ,$$

where V is the value matrix and

$${W}_{i}^{V} ∈ {ℝ}^{{d}_{model} \times {d}_{k}}$$

is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, Softmax layer, and MatMul layer may be in an attention block of the MHA layer. The attention block may implement a scaled dot-product attention mechanism. In some embodiments, the MHA layer includes a plurality of attention blocks that include the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as

$${head}_{i} = Attention ( {QW}_{i}^{Q} , {KW}_{i}^{K} , {VW}_{i}^{V} ) .$$

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A Softmax function may be applied on the scaled matrix in the Softmax layer to compute an attention weight matrix. The attention weight matrix includes attention weights. The attention weights may be probability values ranging from 0 to 1. The Softmax function may emphasize high scores while diminishing low scores, which can enhance the model's ability to determine which tokens should get more attention.

In the MatMul layer, a matrix multiplication operation is performed on the attention weight matrix computed in the Softmax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to form a concatenated matrix. A linear operation (also referred to as “linear transformation”) is performed on the concatenated matrix using a weight matrix in the linear layer. In some embodiments, the MHA may be denoted as MultiHead(Q, K, V)=Concat (head₁, head₂, . . . , headₙ)W^{O}, where Concat denotes concatenation, and W^{O}∈ [symbol] ^{hd}^{ᵥ}^{×d}^{_{model}} is the weight matrix in the corresponding linear layer.

An add & norm layer in the transformer model 800, such as the add & norm layer 842, 844, 852, 854, and 856, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 842 is the MHA layer 841. As another example, the preceding layer of the add & norm layer 854 is the MHA layer 853.

Then the layer normalization operation is applied on the result of the addition operation, which may be denoted as LayerNorm (x+sublayer (x)), where LayerNorm denotes layer normalization, x is the input of the preceding layer, and sublayer (x) denotes the output of the preceding layer. In some embodiments, the layer normalization operation may include a sequence of computations. In an example, the layer normalization operation may include a mean computation, which may be denoted as

$${μ}_{xy} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be a channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−U_{xyz}. The layer normalization operation may further include a variance computation denoted as

$${σ}_{xy}^{2} = {\sum }_{z = 1}^{Z} {D}_{xyz}^{2}$$

and a division computation denoted as

$${M}_{xy} = \frac{1}{\sqrt{\frac{1}{Z} \times ( {σ}_{xy}^{2} + ϵ \times Z )}} .$$

M_{xy} may be a 2D tensor. The layer normalization operation may also convert M_{xy} to a 3D tensor M_{xyz}, e.g., by replicating every data element over z output points. Further, the layer normalization operation may have an element multiplication denoted as

$${A}_{xyz}^{′} = \frac{{A}_{xyz} - {μ}_{xyz}}{\sqrt{\frac{1}{Z} \times ( {σ}_{xy}^{2} + ϵ )}} = ( {A}_{xyz} - {μ}_{xyz} ) \times \frac{1}{\sqrt{\frac{1}{Z} \times ( {σ}_{xy}^{2} + ϵ )}} = {D}_{xyz} \times {M}_{xyz} .$$

The layer normalization operation may further compute

$${A}_{xyz}^{″} = {A}_{xyz}^{′} + \frac{{β}_{z}}{{γ}_{z}}$$

and LN_{xyz}=A″_{xyz}×γ_{z}. LN_{xyz} may be the output of the layer normalization operation.

A feed forward layer (e.g., the feed forward layer 843 and the feed forward layer 855) may be a position-wise fully-connected feed forward network. In an example, the feed forward layer may include two linear layers with an activation function in between. An example of the activation function is Rectified Linear Unit (ReLU).

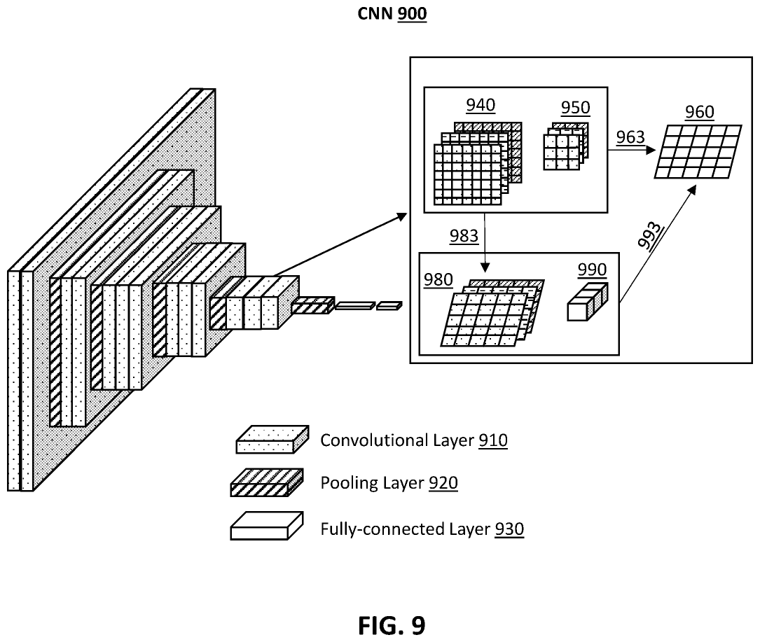

FIG. 9 illustrates an example CNN 900, in accordance with various embodiments. The CNN 900 may be an example of the DNNs described above. For the purpose of illustration, the CNN 900 includes a sequence of layers comprising a plurality of convolutional layers 910 (individually referred to as “convolutional layer 910”), a plurality of pooling layers 920 (individually referred to as “pooling layer 920”), and a plurality of fully-connected layers 930 (individually referred to as “fully-connected layer 930”). In other embodiments, the CNN 900 may include fewer, more, or different layers. In an execution of the CNN 900, the layers of the CNN 900 execute tensor computation that includes many tensor operations, such as convolutions, interpolations, pooling operations, elementwise operations (e.g., elementwise addition, elementwise multiplication, etc.), other types of tensor operations, or some combination thereof.

The convolutional layers 910 summarize the presence of features in inputs to the CNN 900. The convolutional layers 910 function as feature extractors. The first layer of the CNN 900 is a convolutional layer 910. In an example, a convolutional layer 910 performs a convolution on an input tensor 940 (also referred to as IFM 940) and a filter 950. As shown in FIG. 9, the IFM 940 is represented by a 7×7×3 three-dimensional (3D) matrix. The IFM 940 includes 3 input channels, each of which is represented by a 7×7 two-dimensional (2D) matrix. The 7×7 2D matrix includes 7 input elements (also referred to as input points) in each row and 7 input elements in each column. The filter 950 is represented by a 3×3×3 3D matrix. The filter 950 includes 3 kernels, each of which may correspond to a different input channel of the IFM 940. A kernel is a 2D matrix of weights, where the weights are arranged in columns and rows. A kernel can be smaller than the IFM. In the embodiments of FIG. 9, each kernel is represented by a 3×3 2D matrix. The 3×3 kernel includes 3 weights in each row and 3 weights in each column.

Weights can be initialized and updated by backpropagation using gradient descent. The magnitudes of the weights can indicate importance of the filter 950 in extracting features from the IFM 940.

The convolution includes multiply-accumulate (MAC) operations with the input elements in the IFM 940 and the weights in the filter 950. The convolution may be a standard convolution 963 or a depthwise convolution 983. In the standard convolution 963, the whole filter 950 slides across the IFM 940. All the input channels are combined to produce an output tensor 960 (also referred to as output feature map (OFM) 960). The OFM 960 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 9. In embodiments where there are multiple filters, the standard convolution may produce multiple OCs in the OFM 960.

The multiplication applied between a kernel-sized patch of the IFM 940 and a kernel may be a dot product. A dot product is the elementwise multiplication between the kernel-sized patch of the IFM 940 and the corresponding kernel, which is then summed, always resulting in a single value. Because it results in a single value, the operation is often referred to as the “scalar product.” Using a kernel smaller than the IFM 940 is intentional as it allows the same kernel (set of weights) to be multiplied by the IFM 940 multiple times at different points on the IFM 940. Specifically, the kernel is applied systematically to each overlapping part or kernel-sized patch of the IFM 940, left to right, top to bottom. The result from multiplying the kernel with the IFM 940 one time is a single value. As the kernel is applied multiple times to the IFM 940, the multiplication result is a 2D matrix of output elements. As such, the 2D output matrix (i.e., the OFM 960) from the standard convolution 963 is referred to as an OFM.

In the depthwise convolution 983, the input channels are not combined. Rather, MAC operations are performed on an individual input channel and an individual kernel and produce an OC. As shown in FIG. 9, the depthwise convolution 983 produces a depthwise output tensor 980. The depthwise output tensor 980 is represented by a 5×5×3 3D matrix. The depthwise output tensor 980 includes 3 OCs, each of which is represented by a 5×5 2D matrix. The 5×5 2D matrix includes 5 output elements in each row and 5 output elements in each column. Each OC is a result of MAC operations of an input channel of the IFM 940 and a kernel of the filter 950. For instance, the first OC (patterned with dots) is a result of MAC operations of the first input channel (patterned with dots) and the first kernel (patterned with dots), the second OC (patterned with horizontal strips) is a result of MAC operations of the second input channel (patterned with horizontal strips) and the second kernel (patterned with horizontal strips), and the third OC (patterned with diagonal stripes) is a result of MAC operations of the third input channel (patterned with diagonal stripes) and the third kernel (patterned with diagonal stripes). In such a depthwise convolution, the number of input channels equals the number of OCs, and each OC corresponds to a different input channel. The input channels and output channels are referred to collectively as depthwise channels. After the depthwise convolution, a pointwise convolution 993 is then performed on the depthwise output tensor 980 and a 9×1×3 tensor 990 to produce the OFM 960.

The OFM 960 is then passed to the next layer in the sequence. In some embodiments, the OFM 960 is passed through an activation function. An example activation function is rectified linear unit (ReLU). ReLU is a calculation that returns the value provided as input directly, or the value zero if the input is zero or less. The convolutional layer 910 may receive several images as input and calculate the convolution of each of them with each of the kernels. This process can be repeated several times. For instance, the OFM 960 is passed to the subsequent convolutional layer 910 (i.e., the convolutional layer 910 following the convolutional layer 910 generating the OFM 960 in the sequence). The subsequent convolutional layers 910 perform a convolution on the OFM 960 with new kernels and generate a new feature map. The new feature map may also be normalized and resized. The new feature map can be kernelled again by a further subsequent convolutional layer 910, and so on.

In some embodiments, a convolutional layer 910 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 910). The convolutional layers 910 may perform various types of convolutions, such as 2-dimensional convolution, dilated or atrous convolution, spatial separable convolution, depthwise separable convolution, transposed convolution, and so on. The CNN 900 includes 96 convolutional layers 910. In other embodiments, the CNN 900 may include a different number of convolutional layers.

The pooling layers 920 down-sample feature maps generated by the convolutional layers, e.g., by summarizing the presence of features in the patches of the feature maps. A pooling layer 920 is placed between two convolution layers 910: a preceding convolutional layer 910 (the convolution layer 910 preceding the pooling layer 920 in the sequence of layers) and a subsequent convolutional layer 910 (the convolution layer 910 subsequent to the pooling layer 920 in the sequence of layers). In some embodiments, a pooling layer 920 is added after a convolutional layer 910, e.g., after an activation function (e.g., ReLU, etc.) has been applied to the OFM 960.

A pooling layer 920 receives feature maps generated by the preceding convolution layer 910 and applies a pooling operation to the feature maps. The pooling operation reduces the size of the feature maps while preserving their important characteristics. Accordingly, the pooling operation improves the efficiency of the DNN and avoids over-learning. The pooling layers 920 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter of the size. In an example, a pooling layer 920 applied to a feature map of 6×6 results in an output pooled feature map of 3×3. The output of the pooling layer 920 is inputted into the subsequent convolution layer 910 for further feature extraction. In some embodiments, the pooling layer 920 operates upon each feature map separately to create a new set of the same number of pooled feature maps.

The fully-connected layers 930 are the last layers of the DNN. The fully-connected layers 930 may be convolutional or not. The fully-connected layers 930 receive an input operand. The input operand defines the output of the convolutional layers 910 and pooling layers 920 and includes the values of the last feature map generated by the last pooling layer 920 in the sequence. The fully-connected layers 930 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully-connected layer 930 by using a logistic function (binary classification) or a SoftMax function (multi-class classification) as an activation function. In some embodiments, the fully-connected layers 930 multiply each input element by a weight, make the sum, and then apply an activation function (e.g., logistic if N=2, SoftMax if N>2). This is equivalent to multiplying the input operand by the matrix containing the weights.

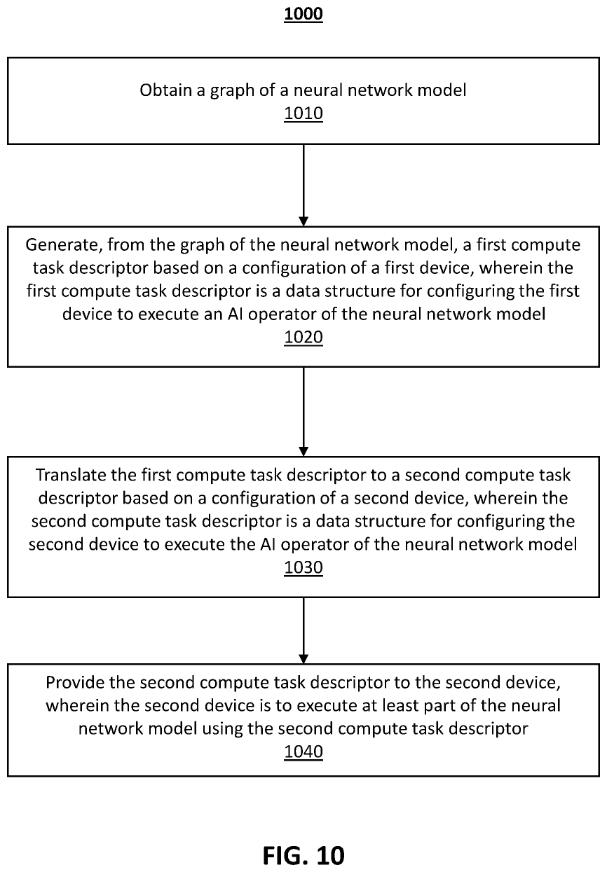

FIG. 10 is a flowchart of a method 1000 of executing a DNN, in accordance with various embodiments. The method 1000 may be performed by the compiler 730 in FIG. 1. Although the method 1000 is described with reference to the flowchart illustrated in FIG. 10, many other methods for executing DNNs may alternatively be used. For example, the order of execution of the steps in FIG. 10 may be changed. As another example, some of the steps may be changed, eliminated, or combined.

The compiler 730 obtains 1010 a graph of a neural network model. In some embodiments, the graph includes nodes representing AI operators and edges representing data flows between the AI operators. In some embodiments, the AI operators include MatMul operator, activation function operator, layer normalization operator, embedding operator, or convolution operator. An example of the graph is the AI inference graph 401 in FIG. 4.

The compiler 730 generates 1020, from the graph of the neural network model, a first compute task descriptor based on a configuration of a first device. The first compute task descriptor is a data structure for configuring the first device to execute an AI operator of the neural network model. In some embodiments, the compiler 730 generates a plurality of task lists for a plurality of compute engines of the first device. A task list comprises one or more compute task descriptors. The one or more compute task descriptors include the first compute task descriptor. In some embodiments, the compiler 730 generates, from the graph of the neural network model, a first copy task descriptor based on the configuration of the first device. The first copy task descriptor is a data structure for configuring the first device to move data for executing the AI operator.

The compiler 730 translates 1030 the first compute task descriptor to a second compute task descriptor based on a configuration of a second device. The second compute task descriptor is a data structure for configuring the second device to execute the AI operator of the neural network model. In some embodiments, the compiler 730 translates the first copy task descriptor to a second copy task descriptor based on the configuration of the second device. The second copy task descriptor is a data structure for configuring the second device to move data for executing the AI operator.

In some embodiments, the compiler 730 generates a new task list for a compute engine of the second device from the plurality of task lists. The new task list comprises the second compute task descriptor. In some embodiments, the compiler 730 generates the new task list by serializing and merging the plurality of task lists based on an order in which AI operators of the neural network model are to be executed. The AI operators comprise the AI operator.

In some embodiments, the first compute task descriptor is for configuring a fixed-function engine of the first device, and the second compute task descriptor is for configuring a programmable engine of the second device. In some embodiments, the fixed-function engine has access to a memory within the first device, and the programmable engine has access to both a memory within the second device and a memory outside the second device. In some embodiments, a storage size of the memory within the first device is larger than a storage size of the memory within the second device.

In some embodiments, the first compute task descriptor is for configuring a fixed-function engine of the first device, and the second compute task descriptor is for configuring a fixed-function engine of the second device. In some embodiments, the fixed-function engine of the first device has access to a memory within the first device, the fixed-function engine of the second device has access to a memory within the second device, and a storage size of the memory within the first device is smaller than or equal to a storage size of the memory within the second device.

The compiler 730 provides 1040 the second compute task descriptor to the second device. The second device is to execute at least part of the neural network model using the second compute task descriptor. In some embodiments, the compiler 730 provides the second copy task descriptor to the second device. A copy engine of the second device is to move the data using the second copy task descriptor. In some embodiments, the data comprises the second compute task descriptor.

FIG. 11 illustrates an example sparse cell 1100, in accordance with various embodiments. The sparse cell 1100 may be a processing cell in a processing engine, e.g., the processing engine 170 in FIG. 1. In the embodiments of FIG. 11, the sparse cell 1100 includes 16 MAC units 1110 (individually referred to as “MAC unit 1110”), which constitutes a MAC array having four rows and four columns. The MAC array has a spatial shape of 4×4, meaning the height of the MAC array is four and the width of the MAC array is also 4. The sparse cell 1100 also includes 16 weight register files 1120 (individually referred to as “weight register file 1120”), 16 activation register files 1130 (individually referred to as “activation register file 1130”), four row buffers 1140 (individually referred to as “row buffer 1140”), and acceleration modules 1160 (individually referred to as “acceleration module 1160”). In other embodiments, the sparse cell 1100 may include fewer, more, or different components. For example, the sparse cell 1100 may include a different number of MAC units 1110, weight register files 1120, activation register files 1130, row buffers 1140, or acceleration modules 1160. As another example, the sparse cell 1100 may include column buffers in lieu of or in addition to the row buffers 1140. Also, the shape (e.g., the height or width) of the MAC array may be different.

The MAC units 1110 are configured to perform MAC operations. Each MAC unit 1110 may include one or more multipliers and one or more adders. A multiplier may multiply an activation with a weight at a time to compute a product. In some embodiments (e.g., embodiments where the MAC unit 1110 includes multiple multipliers), the multipliers may operate simultaneously to process multiple activation-weight pairs and compute multiple products in one cycle. An adder may accumulate products computed by the multipliers. Even though not shown in FIG. 11, the sparse cell may include an adder tree including a plurality of adder tiers. The first tier may receive outputs of a plurality of MAC units 1110. The number of adders in the first tier may be half of the number of the MAC units 1110, and each adder may accumulate the outputs of two MAC units 1110. The second tier may receive outputs of adders in the first tier. The number of adders in the second tier may be half of the number of adders in the first tier, and each adder in the second tier may accumulate the outputs of two adders in the first tier. The adder tree may include one or more other tiers. The last tier may include a single adder that accumulates outputs of adders in the second last tier to compute a partial sum of the sparse cell 1100.

The weight register files 1120 store weights to be processed in MAC operations. In the embodiments of FIG. 11, four weight register files 1120 are grouped into a storage set that stores data to be used by a column of MAC units 1110. There are four storage sets corresponding to the four columns of MAC units 1110. In some embodiments, a weight register file 1120 may correspond to a MAC unit 1110 and store data to be processed by the MAC unit. In some embodiments, all the 16 weight register files 1120 constitute a weight storage unit.

The activation register files 1130 store activations to be processed in MAC operations. In the embodiments of FIG. 11, four activation register files 1130 are grouped into a storage set that stores data to be used by a row of MAC units 1110. There are four storage sets corresponding to the four rows of MAC units 1110. In some embodiments, an activation register file 1130 may correspond to a MAC unit 1110 and store data to be processed by the MAC unit. In some embodiments, all the 16 activation register files 1130 constitute an activation storage unit. The row buffers 1140 store outputs of the MAC units 1110. Each row buffer 1140 may drain outputs of a single row of MAC units 1110.

The acceleration module 1160 facilitates acceleration of computations in the sparse cell 1100 based on mixed formats of weights. In the embodiments of FIG. 11, each acceleration module 1160 may control acceleration of computations in a different MAC unit 1110. The number of acceleration modules 1160 in the sparse cell 1100 is the same as the number of MAC units 1110 in the sparse cell 1100. In other embodiments, an acceleration module 1160 may control acceleration in multiple MAC units 1110. As shown in FIG. 11, each acceleration module 1160 includes a storage unit 1165 and a control logic 1167. The storage unit 1165 stores mixed-format maps. The control logic 1167 may control distributions of activations and weights stored from the weight register files 1120 and the activation register files 1130 to the MAC units 1110 based on mixed-format maps. In some embodiments, the control logic 1167 may distribute a weight operand and a corresponding activation operation to a MAC unit 1110 for an MAC operation. The weight operand may be a subblock (e.g., a column) of a weight block. All the weights in the weight operand may be in the same output channel and have the same spatial position, but the weights may be in different input channels from each other.

In some embodiments, a weight operand may include one or more uncompressed weight and one or more compressed weights. The control logic 1167 may distribute compressed weights to MAC units 1110 in a different manner from which the control logic 1167 distributes uncompressed weights. In some embodiments (e.g., embodiments in which the compressed weights are zeros), the control logic 1167 may select nonzero weights stored in the weight register files 1120 based on the mixed-format map and distribute these nonzero weights to the MAC unit 1110 for computation. The control logic 1167 may also distribute activations, which correspond to the nonzero weights, to the MAC unit 1110 from the activation register files 1130. The control logic 1167 may ignore zero weights and activations corresponding to the zero weights so that these weights and activations can be skipped from computation.

In other embodiments (e.g., embodiments in which the compressed weights have a lower precision than the uncompressed weights), the control logic 1167 may distribute both compressed weights and uncompressed weights to the MAC unit 1110 but in different manners. For example, the control logic 1167 may distribute one compressed weight to the MAC unit 1110 for one computation cycle of the MAC unit 1110 but distribute one uncompressed weight to the MAC unit 1110 for multiple computation cycles of the MAC unit 1110. The MAC unit 1110 may have a multiplier that can compute a product of a compressed weight with its corresponding activation in one computation cycle. The multiplier may compute multiple products for an uncompressed weight. Each of these products may be a result of multiplying a portion of the uncompressed weight with the corresponding activation in one computation cycle. One or more of these products may be shifted and then accumulated with one or more other products to compute the product of the uncompressed weight and the activation. As another example, the control logic 1167 may distribute multiple compressed weights to the MAC unit 1110 for one computation cycle of the MAC unit 1110 but distribute one uncompressed weight to the MAC unit 1110 for one computation cycle of the MAC unit 1110. The MAC unit 1110 in this example may have multiple multipliers that can compute multiple products for an uncompressed weight in one operating cycle, in which each multiplier may multiply a portion of the uncompressed weight with the corresponding activation. Each multiplier may multiply a compressed weight with the corresponding activation in one compute cycle so that multiple multipliers can handle multiple uncompressed weights in one computation cycle.

As shown in FIG. 11, the sparse cell 1100 is associated with multiplexers (MUXs) 1103, 1104, 1105, and 1106. In other embodiments, the sparse cell 1100 may be associated with a different number of MUXs or other devices. The MUX 1103 facilitates loading weights, e.g., from the local memory 130 in FIG. 1, into the weight register files 1120. The MUX 1104 facilitates loading activations, e.g., from the local memory 130 in FIG. 1, into the activation register files 1130. The MUX 1105 facilitates loading mixed-format maps into the storage unit 1165. The MUX 1106 may be a drain MUX that can facilitate draining outputs of the MAC units 1110, e.g., to the local memory 130 in FIG. 1.

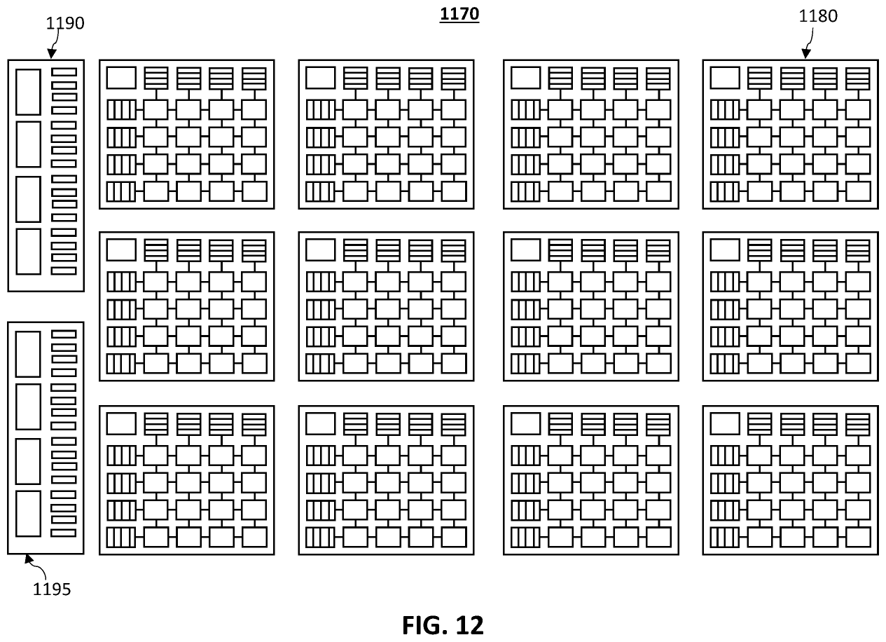

FIG. 12 illustrates an example sparse cell array 1170, in accordance with various embodiments. The sparse cell array 1170 may be an example of the processing engine 170 in FIG. 1. In FIG. 12, the sparse cell array 1170 includes sparse cells 1180 (individually referred to as “sparse cell 1180”) arranged in four columns and four rows, an activation memory 1190, and a weight memory 1195. In other embodiments, the sparse cell array 1170 may include fewer, more, or different components. For instance, the sparse cell array 1170 may include a different number of columns, rows, or sparse cells 1180.

Each sparse cell 1180 may perform accelerated MAC operations. MAC operations in the sparse cells 1180 may be accelerated based on mixed formats of weights. An embodiment of a sparse cell 1180 may be the sparse cell 1100 in FIG. 11. The activation memory 1190 stores activations, such as activations in input tensors of neural network operations. Activations may be loaded from the activation memory 1190 to sparse cells 1180, e.g., to activation register files. The weight memory 1195 stores weights, such as weights in filters of neural network operations. Weights may be loaded from the weight memory 1195 to sparse cells 1180, e.g., to weight register files. The activation memory 1190 or weight memory 1195 may be a buffer.

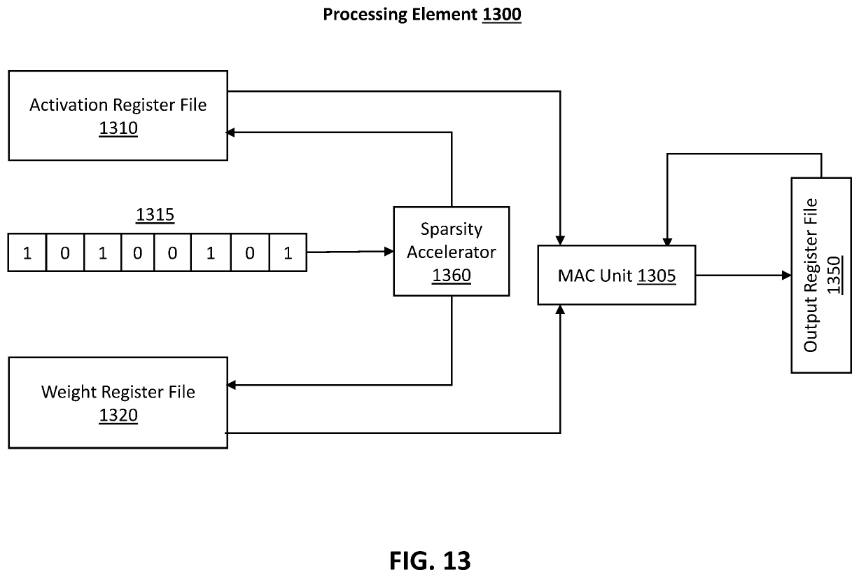

FIG. 13 illustrates an example PE 1300, in accordance with various embodiments. The PE 1300 may be a unit component of a processing cell, e.g., a processing cell in the processing engine 170 in FIG. 1. In the embodiments of FIG. 13, the PE 1300 includes an MAC unit 1305, an activation register file 1310, a weight register file 1320, an output register file 1350, and a sparsity accelerator 1360. In other embodiments, the PE 1300 may include fewer, more, or different components.

The activation register file 1310 stores an activation operand, which may be a context. The activation register file 1310 may be an example of the activation register files 1130 in FIG. 11. The weight register file 1320 stores a weight operand. The weight register file 1320 may be an example of the weight register files 1120 in FIG. 11. The activation operand and weight operand may be loaded from a memory (e.g., the local memory 130 in FIG. 1) into the activation register file 1310 and the weight register file 1320, respectively. The sparsity accelerator 1360 receives a sparsity bitmap 1315 that corresponds to the sparse tensor in the weight register file 1320. The sparsity bitmap 1315 may be a combined sparsity bitmap when the MAC unit 1305 operates in a combined compute mode. The sparsity bitmap 1315 may be an activation sparsity bitmap when the MAC unit 1305 operates in an activation compute mode. The sparsity bitmap 1315 may be a weight sparsity bitmap when the MAC unit 1305 operates in a weight compute mode. The sparsity bitmap 1315 may have the same size (e.g., the same number of elements) as or a larger size than the activation operand or the weight operand.

Using the sparsity bitmap 1315, the sparsity accelerator 1360 selects four activations from the activation register file 1310 and selects four weights from the weight register file 1320. The sparsity accelerator 1360 transmits the selected activations and weights to the MAC unit 1305. These selected data elements correspond to the nonzero elements of the sparsity bitmap 1315. The four selected activations and the four selected weights may constitute four activation-weight pairs. A multiplier in the MAC unit 1305 may compute a product based on an activation-weight pair. The MAC unit 1305 may compute four products in total. The MAC unit 1305 may compute the four products in parallel. The four products may be provided to an adder tree in the MAC unit 1305. The MAC unit 1305 may compute a unit-level internal partial sum from the four products.

The four unselected elements of the dense tensor are not processed to save power and time, which would not impact the value of the unit-level internal partial sum. For instance, when the dense tensor is a dense activation tensor, the weights corresponding to the unselected activations are zeros so the products of the unselected activations and the weights would all be zero and have no contribution to the unit-level internal partial sum or other partial sums computed by the sparse cell. Similarly, when the dense tensor is a dense weight tensor, the activations corresponding to the unselected weights are zeros so the products of the unselected weights and the activations would all be zero and have no contribution to the unit-level internal partial sum or other partial sums computed by the sparse cell. In other embodiments, the MAC unit 1305 may operate in a dense mode in which the sparsity bitmap 1315 is not used and the sparsity accelerator 1360 is inactive. The MAC unit 1305 may process all the activations in the activation operand and all the weights in the weight operand.

The unit-level internal partial sum may be stored in the output register file 1350. In some embodiments, the unit-level internal partial sum may be used multiple times. For instance, the activation operand may represent N data blocks in the input tensor of the convolution, where N is an integer greater than 1. Instead of processing all the N data blocks to compute N unit-level internal partial sums, the unit-level internal partial sum is computed once and used N times in the convolutional layers as N unit-level internal partial sums.

In some embodiments, the PE 1300 receives one or more PE-level internal partial sums from one or more other PEs. The adder 1340 or an accumulator (not shown in FIG. 13) can accumulate the one or more PE-level internal partial sums with the PE-level internal partial sum of the PE 1300 and store the result of the accumulation (i.e., a multi-PE internal partial sum) in the output register file 1350. The one or more other PEs may be in the same column as the PE 1300 in a sparse cell. The multi-unit internal partial sum may be a column-level internal partial sum. In some embodiments, the PE-level internal partial sum of the PE 1300 or the multi-unit internal partial sum may be sent to one or more other PEs for further accumulation.

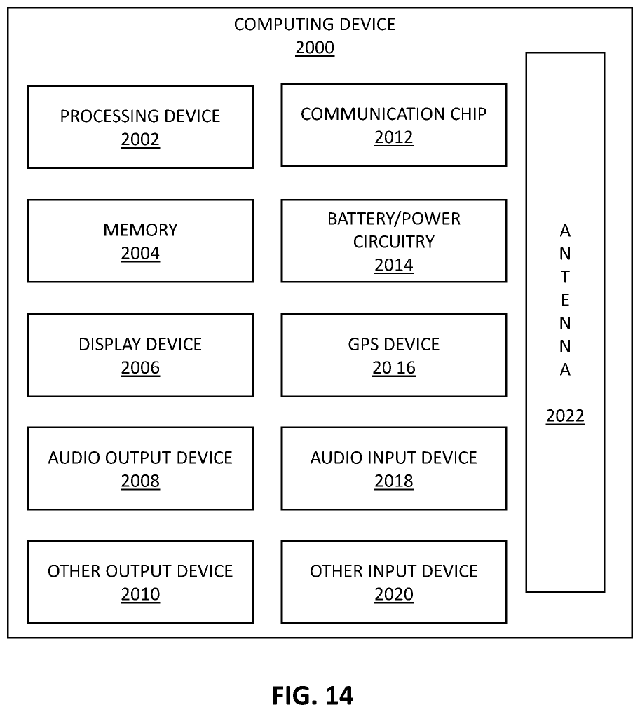

FIG. 14 is a block diagram of an example computing device 2000, in accordance with various embodiments. In some embodiments, the computing device 2000 can be used as at least part of an AI system that includes the NPU 101 and system memory 110 in FIG. 1. A number of components are illustrated in FIG. 14 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single system on a chip (SoC) die. Additionally, in various embodiments, the computing device 2000 may not include one or more of the components illustrated in FIG. 14, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The computing device 2000 may include a memory 2004, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to execute DNNs, such as the method 1000 described in conjunction with FIG. 10 or some operations performed by one or more components of the AI system 100 in FIG. 1 (e.g., the DNN module 103). The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides one or more non-transitory computer-readable media storing instructions executable to perform operations, the operations including obtaining a graph of a neural network model; generating, from the graph of the neural network model, a first compute task descriptor based on a configuration of a first device, in which the first compute task descriptor is a data structure for configuring the first device to execute an artificial intelligence (AI) operator of the neural network model; translating the first compute task descriptor to a second compute task descriptor based on a configuration of a second device, in which the second compute task descriptor is a data structure for configuring the second device to execute the AI operator of the neural network model; and providing the second compute task descriptor to the second device, in which the second device is to execute at least part of the neural network model using the second compute task descriptor.

Example 2 provides the one or more non-transitory computer-readable media of example 1, in which the first compute task descriptor is for configuring a fixed-function engine of the first device, and in which the second compute task descriptor is for configuring a programmable engine of the second device.

Example 3 provides the one or more non-transitory computer-readable media of example 2, in which the fixed-function engine has access to a memory within the first device, and in which the programmable engine has access to both a memory within the second device and a memory outside the second device.

Example 4 provides the one or more non-transitory computer-readable media of example 3, in which a storage size of the memory within the first device is larger than a storage size of the memory within the second device.

Example 5 provides the one or more non-transitory computer-readable media of example 1, in which the first compute task descriptor is for configuring a fixed-function engine of the first device, and in which the second compute task descriptor is for configuring a fixed-function engine of the second device.

Example 6 provides the one or more non-transitory computer-readable media of example 5, in which the fixed-function engine of the first device has access to a memory within the first device, in which the fixed-function engine of the second device has access to a memory within the second device, and in which a storage size of the memory within the first device is smaller than or equal to a storage size of the memory within the second device.

Example 7 provides the one or more non-transitory computer-readable media of any one of examples 1-6, in which the operations further include generating, from the graph of the neural network model, a first copy task descriptor based on the configuration of the first device, in which the first copy task descriptor is a data structure for configuring the first device to move data for executing the AI operator; translating the first copy task descriptor to a second copy task descriptor based on the configuration of the second device, in which the second copy task descriptor is a data structure for configuring the second device to move data for executing the AI operator; and providing the second copy task descriptor to the second device, in which a copy engine of the second device is to move the data using the second copy task descriptor.

Example 8 provides the one or more non-transitory computer-readable media of example 7, in which the data includes the second compute task descriptor.

Example 9 provides the one or more non-transitory computer-readable media of any one of examples 1-8, in which the operations further include generating a plurality of task lists for a plurality of compute engines of the first device, a task list including one or more compute task descriptors, the one or more compute task descriptors including the first compute task descriptor; and generating a new task list for a compute engine of the second device from the plurality of task lists, the new task list including the second compute task descriptor.

Example 10 provides the one or more non-transitory computer-readable media of example 9, in which generating the new task list includes serializing and merging the plurality of task lists based on an order in which AI operators of the neural network model are to be executed, the AI operators including the AI operator.

Example 11 provides an apparatus, including a computer processor for executing computer program instructions; and a non-transitory computer-readable memory storing computer program instructions executable by the computer processor to perform operations, the operations including obtaining a graph of a neural network model, generating, from the graph of the neural network model, a first compute task descriptor based on a configuration of a first device, in which the first compute task descriptor is a data structure for configuring the first device to execute an artificial intelligence (AI) operator of the neural network model, translating the first compute task descriptor to a second compute task descriptor based on a configuration of a second device, in which the second compute task descriptor is a data structure for configuring the second device to execute the AI operator of the neural network model, and providing the second compute task descriptor to the second device, in which the second device is to execute at least part of the neural network model using the second compute task descriptor.

Example 12 provides the apparatus of example 11, in which the first compute task descriptor is for configuring a fixed-function engine of the first device, and in which the second compute task descriptor is for configuring a programmable engine of the second device.

Example 13 provides the apparatus of example 12, in which the fixed-function engine has access to a memory within the first device, and in which the programmable engine has access to both a memory within the second device and a memory outside the second device.

Example 14 provides the apparatus of example 13, in which a storage size of the memory within the first device is larger than a storage size of the memory within the second device.

Example 15 provides the apparatus of example 11, in which the first compute task descriptor is for configuring a fixed-function engine of the first device, and in which the second compute task descriptor is for configuring a fixed-function engine of the second device.

Example 16 provides the apparatus of example 15, in which the fixed-function engine of the first device has access to a memory within the first device, in which the fixed-function engine of the second device has access to a memory within the second device, and in which a storage size of the memory within the first device is smaller than or equal to a storage size of the memory within the second device.

Example 17 provides the apparatus of any one of examples 11-16, in which the operations further include generating, from the graph of the neural network model, a first copy task descriptor based on the configuration of the first device, in which the first copy task descriptor is a data structure for configuring the first device to move data for executing the AI operator; translating the first copy task descriptor to a second copy task descriptor based on the configuration of the second device, in which the second copy task descriptor is a data structure for configuring the second device to move data for executing the AI operator; and providing the second copy task descriptor to the second device, in which a copy engine of the second device is to move the data using the second copy task descriptor.

Example 18 provides the apparatus of example 17, in which the data includes the second compute task descriptor.

Example 19 provides the apparatus of any one of examples 11-18, in which the operations further include generating a plurality of task lists for a plurality of compute engines of the first device, a task list including one or more compute task descriptors, the one or more compute task descriptors including the first compute task descriptor; and generating a new task list for a compute engine of the second device from the plurality of task lists, the new task list including the second compute task descriptor.

Example 20 provides the apparatus of example 19, in which generating the new task list includes serializing and merging the plurality of task lists based on an order in which AI operators of the neural network model are to be executed, the AI operators including the AI operator.

Example 21 provides a method including obtaining a graph of a neural network model; generating, from the graph of the neural network model, a first compute task descriptor based on a configuration of a first device, in which the first compute task descriptor is a data structure for configuring the first device to execute an artificial intelligence (AI) operator of the neural network model; translating the first compute task descriptor to a second compute task descriptor based on a configuration of a second device, in which the second compute task descriptor is a data structure for configuring the second device to execute the AI operator of the neural network model; and providing the second compute task descriptor to the second device, in which the second device is to execute at least part of the neural network model using the second compute task descriptor.

Example 22 provides the method of example 21, in which the first compute task descriptor is for configuring a fixed-function engine of the first device, and in which the second compute task descriptor is for configuring a programmable engine of the second device.

Example 23 provides the method of example 22, in which the fixed-function engine has access to a memory within the first device, in which the programmable engine has access to both a memory within the second device and a memory outside the second device, and in which a storage size of the memory within the first device is larger than a storage size of the memory within the second device.

Example 24 provides the method of any one of examples 21-23, further including generating, from the graph of the neural network model, a first copy task descriptor based on the configuration of the first device, in which the first copy task descriptor is a data structure for configuring the first device to move data for executing the AI operator; translating the first copy task descriptor to a second copy task descriptor based on the configuration of the second device, in which the second copy task descriptor is a data structure for configuring the second device to move data for executing the AI operator; and providing the second copy task descriptor to the second device, in which a copy engine of the second device is to move the data using the second copy task descriptor.

Example 25 provides the method of any one of examples 21-24, further including generating a plurality of task lists for a plurality of compute engines of the first device, a task list including one or more compute task descriptors, the one or more compute task descriptors including the first compute task descriptor; and generating a new task list for a compute engine of the second device by serializing and merging the plurality of task lists based on an order in which AI operators of the neural network model are to be executed, the new task list including the second compute task descriptor, the AI operators including the AI operator.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. One or more non-transitory computer-readable media storing instructions executable to perform operations, the operations comprising:
obtaining a graph of a neural network model;
generating, from the graph of the neural network model, a first compute task descriptor based on a configuration of a first device, wherein the first compute task descriptor is a data structure for configuring the first device to execute an artificial intelligence (AI) operator of the neural network model;
translating the first compute task descriptor to a second compute task descriptor based on a configuration of a second device, wherein the second compute task descriptor is a data structure for configuring the second device to execute the AI operator of the neural network model; and
providing the second compute task descriptor to the second device, wherein the second device is to execute at least part of the neural network model using the second compute task descriptor.

2. The one or more non-transitory computer-readable media of claim 1, wherein the first compute task descriptor is for configuring a fixed-function engine of the first device, and wherein the second compute task descriptor is for configuring a programmable engine of the second device.

3. The one or more non-transitory computer-readable media of claim 2, wherein the fixed-function engine has access to a memory within the first device, and wherein the programmable engine has access to both a memory within the second device and a memory outside the second device.

4. The one or more non-transitory computer-readable media of claim 3, wherein a storage size of the memory within the first device is larger than a storage size of the memory within the second device.

5. The one or more non-transitory computer-readable media of claim 1, wherein the first compute task descriptor is for configuring a fixed-function engine of the first device, and wherein the second compute task descriptor is for configuring a fixed-function engine of the second device.

6. The one or more non-transitory computer-readable media of claim 5, wherein the fixed-function engine of the first device has access to a memory within the first device, wherein the fixed-function engine of the second device has access to a memory within the second device, and wherein a storage size of the memory within the first device is smaller than or equal to a storage size of the memory within the second device.

7. The one or more non-transitory computer-readable media of claim 1, wherein the operations further comprise:
generating, from the graph of the neural network model, a first copy task descriptor based on the configuration of the first device, wherein the first copy task descriptor is a data structure for configuring the first device to move data for executing the AI operator;
translating the first copy task descriptor to a second copy task descriptor based on the configuration of the second device, wherein the second copy task descriptor is a data structure for configuring the second device to move data for executing the AI operator; and
providing the second copy task descriptor to the second device, wherein a copy engine of the second device is to move the data using the second copy task descriptor.

8. The one or more non-transitory computer-readable media of claim 7, wherein the data comprises the second compute task descriptor.

9. The one or more non-transitory computer-readable media of claim 1, wherein the operations further comprise:
generating a plurality of task lists for a plurality of compute engines of the first device, a task list comprising one or more compute task descriptors, the one or more compute task descriptors including the first compute task descriptor; and
generating a new task list for a compute engine of the second device from the plurality of task lists, the new task list comprising the second compute task descriptor.

10. The one or more non-transitory computer-readable media of claim 9, wherein generating the new task list comprises serializing and merging the plurality of task lists based on an order in which AI operators of the neural network model are to be executed, the AI operators comprising the AI operator.

11. An apparatus, comprising:
a computer processor for executing computer program instructions; and
a non-transitory computer-readable memory storing computer program instructions executable by the computer processor to perform operations, the operations comprising:
obtaining a graph of a neural network model,
generating, from the graph of the neural network model, a first compute task descriptor based on a configuration of a first device, wherein the first compute task descriptor is a data structure for configuring the first device to execute an artificial intelligence (AI) operator of the neural network model,
translating the first compute task descriptor to a second compute task descriptor based on a configuration of a second device, wherein the second compute task descriptor is a data structure for configuring the second device to execute the AI operator of the neural network model, and
providing the second compute task descriptor to the second device, wherein the second device is to execute at least part of the neural network model using the second compute task descriptor.

12. The apparatus of claim 11, wherein the first compute task descriptor is for configuring a fixed-function engine of the first device, and wherein the second compute task descriptor is for configuring a programmable engine of the second device.

13. The apparatus of claim 12, wherein the fixed-function engine has access to a memory within the first device, wherein the programmable engine has access to both a memory within the second device and a memory outside the second device, and a storage size of the memory within the first device is larger than a storage size of the memory within the second device.

14. The apparatus of claim 11, wherein:
the first compute task descriptor is for configuring a fixed-function engine of the first device,
the second compute task descriptor is for configuring a fixed-function engine of the second device,
the fixed-function engine of the first device has access to a memory within the first device,
the fixed-function engine of the second device has access to a memory within the second device, and
a storage size of the memory within the first device is smaller than or equal to a storage size of the memory within the second device.

15. The apparatus of claim 11, wherein the operations further comprise:
generating, from the graph of the neural network model, a first copy task descriptor based on the configuration of the first device, wherein the first copy task descriptor is a data structure for configuring the first device to move data for executing the AI operator;
translating the first copy task descriptor to a second copy task descriptor based on the configuration of the second device, wherein the second copy task descriptor is a data structure for configuring the second device to move data for executing the AI operator; and
providing the second copy task descriptor to the second device, wherein a copy engine of the second device is to move the data using the second copy task descriptor.

16. The apparatus of claim 11, wherein the operations further comprise:
generating a plurality of task lists for a plurality of compute engines of the first device, a task list comprising one or more compute task descriptors, the one or more compute task descriptors including the first compute task descriptor; and
generating a new task list for a compute engine of the second device from the plurality of task lists, the new task list comprising the second compute task descriptor, wherein generating the new task list comprises serializing and merging the plurality of task lists based on an order in which AI operators of the neural network model are to be executed, the AI operators comprising the AI operator.

17. A method comprising:
obtaining a graph of a neural network model;
generating, from the graph of the neural network model, a first compute task descriptor based on a configuration of a first device, wherein the first compute task descriptor is a data structure for configuring the first device to execute an artificial intelligence (AI) operator of the neural network model;
translating the first compute task descriptor to a second compute task descriptor based on a configuration of a second device, wherein the second compute task descriptor is a data structure for configuring the second device to execute the AI operator of the neural network model; and
providing the second compute task descriptor to the second device, wherein the second device is to execute at least part of the neural network model using the second compute task descriptor.

18. The method of claim 17, wherein the first compute task descriptor is for configuring a fixed-function engine of the first device, and wherein the second compute task descriptor is for configuring a programmable engine of the second device.

19. The method of claim 17, further comprising:
generating, from the graph of the neural network model, a first copy task descriptor based on the configuration of the first device, wherein the first copy task descriptor is a data structure for configuring the first device to move data for executing the AI operator;
translating the first copy task descriptor to a second copy task descriptor based on the configuration of the second device, wherein the second copy task descriptor is a data structure for configuring the second device to move data for executing the AI operator; and
providing the second copy task descriptor to the second device, wherein a copy engine of the second device is to move the data using the second copy task descriptor.

20. The method of claim 17, further comprising:
generating a plurality of task lists for a plurality of compute engines of the first device, a task list comprising one or more compute task descriptors, the one or more compute task descriptors including the first compute task descriptor; and
generating a new task list for a compute engine of the second device by serializing and merging the plurality of task lists based on an order in which AI operators of the neural network model are to be executed, the new task list comprising the second compute task descriptor, the AI operators comprising the AI operator.
